(19) United States
(12) Patent Application Publication
(10) Pub. No.: US 2024/0226881 A9
(43) Pub. Date: Jul. 11, 2024

(54) MICROFLUIDIC BASED METHODS TO STUDY INTERCELLULAR COMMUNICATIONS

(71) Applicant: GEORGE MASON UNIVERSITY, Fairfax, VA (US)

(72) Inventors: Remi VENEZIANO, McLean, VA (US); Ramin M. HAKAMI, Bristow, VA (US); Hunter MASON, Orange, CT (US)

(21) Appl. No.: 18/235,564

(22) Filed: Aug. 18, 2023

Related U.S. Application Data
(60) Provisional application No. 63/380,164, filed on Oct. 19, 2022.

(51) Int. Cl. B01L 3/00

(52) U.S. Cl. CPC B01L 3/502715; B01L 2300/0681; B01L 2300/0816; B01L 2300/0861

(57) ABSTRACT

A microfluidic intercellular communication analysis device includes a coverslip and a Polydimethylsiloxane (PDMS) layer attached to the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the donor cell channel and the recipient cell channel each comprising inlets and outlets having an arc angle ranging from 180° to 300°, the arc angle structured to prevent cell aggregation in the inlets, the outlets and/or channel surfaces thereof, wherein upon injecting the donor cell population and the recipient cell population, the target subject is imaged by an imaging device and analyzed for intercellular communication and/or functional characterizations for ensuing intercellular communication effects.

### CROSS-REFERENCE TO RELATED APPLICATIONS

The instant application is entitled to priority under 35 U.S.C. § 119(e) to U.S. Provisional Application No. 63/380,164 filed Oct. 19, 2022, which is hereby incorporated by reference in its entirety.

### GOVERNMENT INTEREST

This invention was made with government support under grant number AI137981 awarded by the National Institutes of Health. The government has certain rights in the invention.

### FIELD

The general inventive concepts relate to the field of modified microfluidic device for cell-to-cell communication analysis.

### BACKGROUND

Extracellular vesicles (EVs) are nano-sized, membrane-bound vesicles secreted from cells that can transport cargo such as lipids, nucleic acids, DNA, RNA, proteins, etc., between cells as a form of cell-cell communication (6). Progression of variety of disease states largely depend on the secretion and subsequent uptake of bioactive EVs (1). Different EV subtypes have been characterized on the basis of, for example, their biogenesis, release pathways, size, functions, etc. (6) These vesicles are heterogeneous in nature, and can range from 30 nm up to 10 μm in size (2). Some of these subtypes are illustrated in FIG. 14. One subtype includes oncosomes having a size larger than 1,000 nm. Oncosomes are produced mainly by malignant cells and include markers such as CK18, GOT1, GAPDH and glutaminase. Another subtype includes microvesicles (MVs) having a size ranging from 200 to 1,000 nm. MVs bud directly from the cell's plasma membrane and include markers such as ARF6, WAMP3 and Annexin A1. The small EV subtype includes exosomes ranging from 30-150 nm in diameter and secreted by nearly every cell type in the human body (5,6). Exosomes include markers such as CD63, Syntenin-1, Alix and Rab27a. ARMMs are another small EV subtype having a size ranging from 50-200 nm and carry markers such as ARRDC1, Tsg101. Further, there are extracellular particles such as exomeres and supermeres which are less than 50 nm in size. Exomeres carry markers such as Hsp90-β, ENO1 and GANAB, and supermeres include markers such as TGF-β1, AGO2, ACE2 and PCSK9. Nearly all cell types release multiple types of EVs and particles.

Among these EVs, exosomes are a key player in the EV-based crosstalk that regulates disease progression (3,4). Their membranes and lumens are enriched with bioactive cargo molecules such as proteins, lipids, and nucleic acids that can be delivered to neighboring or distant recipient cells (5,7,8). Recently, exosomes have been shown to play a major modulatory role that can either promote or inhibit the progression of many human diseases, such as cancer, neurological disorders, cardiovascular diseases, and infectious diseases (3, 9-15). The potential of exosomes for use as diagnostic biomarkers or for the design of effective therapeutics and vaccines is being intensely investigated, given their potent regulatory function, availability in most bodily fluids, and incorporation of various disease-specific cargoes (16).

However, progress in mechanistic understanding of EV functions and relevance across many specific diseases is still extremely limited and much remains to be explored. This is in part due to the difficulty of working with EVs such as exosomes, both in vitro and in vivo. For example, the gold standard for performing in vitro EV studies can require lengthy and tedious series of centrifugation steps that include density gradient separations to purify them from the culture supernatant. Furthermore, large amounts of producer cells and culture media are needed per isolation to recover sufficient material (17). Alternative isolation methods such as size-exclusion chromatography are relatively costly and typically not able to sufficiently enrich the vesicles to obtain suitable yields for some applications, or to provide sufficient separation of exosomes from larger EVs (18).

Similarly, in vivo EV studies are inefficient. Due to their size and the complex tissue environment, direct observation of EVs in vivo is not easily achievable (19). Further, it is not yet readily possible to effectively target functionalized EVs to distinct cell types in vivo in order to monitor specific interactions and functions without potential complications arising from EV alteration (20). In addition to overcoming these limitations, it is highly desirable to have physiologically relevant functional assays that bridge purely in vitro and in vivo experimental designs and more closely replicate the in vivo setting, where EVs are constitutively exchanged between donor and recipient cells (21). Microfluidic technology has been utilized to alleviate some of the challenges associated with EV studies. This includes enhanced sorting, detection and isolation of EVs (18), efficient surface modification (22), and use in extrusion for the generation of new vesicles (23). However, current microfluidic technology (25) is limited with regard to simulating native exchange between co-cultured cells in order to enable functional studies. Further, they suffer from structural limitations that lead to, e.g., without limitation, cell aggregation within inlets and/or outlets of the microfluidic channels thereof, difficulty to retrieve the cells, negatively impacting the analysis and/or investigation of cell-cell communication of target subjects (e.g., EVs, particles, protein, etc.) (25).

There remains a need for improved microfluidic devices for investigating and analyzing intercellular communications, as well as methods of using the microfluidic devices for such investigation and analysis.

### SUMMARY

Provided is a microfluidic intercellular communication analysis device including a coverslip and a polydimethylsiloxane (PDMS) layer attached to upper surface of the coverslip. The PDMS layer includes a plurality of microfluidic channels each having an inlet and an outlet. The plurality of microfluidic channels includes a donor cell channel structured to receive a donor cell population, a recipient cell channel structured to receive at least a recipient cell population and a matrix channel including a diffusion barrier having pores, the diffusion barrier being structured to mimic extracellular matrix and conduit a target subject from the donor cell channel to the recipient cell channel through the pores, the donor cell channel and the recipient cell channel each comprising inlets and outlets having an arc angle ranging from 180° to 300°, the arc angle structured to prevent cell aggregation in the inlets, the outlets and/or channel surfaces of the donor cell channel and the recipient cell channel, wherein upon injection of the donor cell population and the recipient cell population into respective cell channels, the target subject is imaged by an imaging device couplable to the microfluidic intercellular communication analysis device and analyzed for intercellular communication thereof.

In some embodiments, the PDMS layer has a thickness of 3-4 mm such that the magnification of the imaging device required for the target subject is achieved without bending or damaging the coverslip.

In some embodiments, the matrix channel is selectively activated by a plasma pulse directed only at the matrix channel using an electrode placed in an outlet of the matrix channel and a tip of a plasma generator placed in an inlet of the matrix channel with inlets and outlets of the donor cell channel and the recipient cell channel being blocked.

In some embodiments, the diffusion barrier comprises a hydrogel. In further embodiments, the hydrogel is a porous hydrogel having a pore size appropriate for passing the target subject from the donor cell channel into the recipient cell channel via the matrix channel. In yet further embodiments, the porous hydrogel is Matrigel or PEGDA gel.

In some embodiments, inlet and outlet of the matrix channel each comprise a 16 gauge circumference so as to allow a larger pool of the diffusion barrier comprising a hydrogel to be injected into the matrix channel as compared to hydrogel pools allowed to be injected into matrix channels having inlets and outlets with an 18 gauge circumference.

In some embodiments, the matrix channel comprises first and second arrays of transversely spaced-apart matrix ribs, the first array of the transversely spaced-apart matrix ribs is offset from the second array of the transversely spaced-apart matrix ribs by a transverse distance so as to improve diffusion barrier injection into the matrix channel as compared to diffusion barrier injection made into matrix channels having transversely aligned first and second arrays of spaced-apart matrix ribs.

In some embodiments, the donor cell channel and the recipient cell channel each comprise inlets having a larger gauge circumference than cell channel inlets structured to accommodate only isolated cells such that the donor cell channel and the recipient cell channel are structured to accommodate target subjects larger than isolated cells, the target subjects comprising tissues or organoids.

In some embodiments, the donor cell channel and the recipient cell channel each comprise inlets having a larger gauge circumference than cell channel inlets structured to accommodate only isolated cells such that the donor cell channel inlet and the recipient cell channel inlet are structured to accommodate target subjects larger than isolated cells, the target subjects comprising tissues or organoids.

In some embodiments, inlets and outlets of the donor cell channel and the recipient cell channel are structured to have a specific gauge diameter such that a seal is created between surfaces of the inlets and surface of an injection device during cell population injection.

In some embodiments, the donor cell channel and the recipient cell channel are structured to have a height that prevents cell aggregation in the inlets, the outlets and/or the channel surfaces.

In some embodiments, the height ranges from 200 μm to 400 μm.

In some embodiments, the PDMS layer is hydrophobized at a temperature ranging from 180° C. to 250° C. for a period ranging from 60 minutes to 70 minutes.

In some embodiments, the donor or recipient cell population is injected into its respective cell channel via a tip of a pipette disposed within respective inlet for a predefined time and volume such that the cell population is transferred from the tip of the pipette to respective cell channel based on gravity, the pipette comprising the cell population.

In some embodiments, the donor or recipient cell population is extracted from its respective cell channel via an empty pipette tip disposed within respective outlet for a predefined volume, the cell population being pushed into the empty pipette tip by injecting cell media into respective inlet via a syringe pump.

In some embodiments, the target subject comprises extracellular vesicles (EVs), particles, proteins, small biological molecules, or nucleic acids. In some embodiments, intercellular communication of the target subject is analyzed for disease progression, utilizing the target subject for delivering medicine, applying therapeutic effects, diagnostic purposes, regenerative medicine, providing immunization against at least infectious diseases or cancer, and any other appropriate investigative research.

Provided is a microfluidic intercellular communication analysis system including a microfluidic intercellular communication analysis device including a coverslip and a polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the diffusion barrier being structured to mimic extracellular matrix and conduit a target subject from the donor cell channel to the recipient cell channel through the pores, the donor cell channel and the recipient cell channel each comprising inlets and outlets having an arc angle ranging from 180° to 300°, the arc angle structured to prevent cell aggregation in the inlets, the outlets and/or channel surfaces of the donor cell channel and the recipient cell channel, and an imaging device couplable to the microfluidic intercellular communication analysis device and structured to automatically and continuously acquire images of the target subject within the plurality of microfluidic channels for a period upon injection of the donor cell population and the recipient cell population into respective cell channels. In some embodiments, the acquired images are analyzed for intercellular communication of the target subject.

In some embodiments, the imaging device comprises a microscope, a camera or other appropriate image capture devices.

Provided is a method of performing intercellular communication of a target subject. The method includes providing a microfluidic intercellular communication analysis device that includes a coverslip and a Polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the diffusion barrier being structured to mimic extracellular matrix and conduit the target subject from the donor cell channel to the recipient cell channel through the pores, the donor cell channel and the recipient cell channel each comprising inlets and outlets having an arc angle ranging from 180° to 300°, the arc angle structured to prevent cell aggregation in the inlets, the outlets and/or channel surfaces of the donor cell channel and the recipient cell channel; injecting the donor cell population including the target subject into the donor cell channel via an inlet of the donor cell channel with an injection device; injecting the recipient cell population into the recipient cell channel via an inlet of the recipient cell channel with the injection device; acquiring images of the target subject within the plurality of microfluidic channels via the imaging device over a period; and analyzing the target subject based at least in part on the acquired images.

In some embodiments, the injecting the donor cell population and the injecting the recipient cell population each includes injecting into respective cell channel via an empty pipette tip of a pipette disposed within respective inlet for a predefined time and volume such that the cell population is transferred from the tip of the pipette to respective cell channel based on gravity, the pipette comprising the cell population.

In some embodiments, the method further includes extracting at least one of the donor cell population and the recipient cell population.

In some embodiments, the extracting at least one of the donor cell population and the recipient cell population includes placing an empty pipette tip within respective outlet; upon placing the tip of the empty pipette within respective outlet, injecting cell media into respective inlet via a syringe pump; and receiving the at least one of the donor cell population and the recipient cell population into the empty pipette via the tip for a predefined volume.

### BRIEF DESCRIPTION OF THE FIGURES

FIG. 1 illustrates an exemplary microfluidic intercellular communication analysis system according to a non-limiting, example embodiment of the disclosed concept.

FIGS. 2A-2F illustrate exemplary microfluidic intercellular communication analysis devices according to non-limiting, example embodiments of the disclosed concept. FIG. 2A illustrates an exemplary schematic of a 3-channel microfluidic intercellular communication analysis device depicting a plurality of microfluidic channels therein. FIG. 2B illustrates a front view of an exemplary schematic of the 3-channel microfluidic intercellular communication analysis device. FIG. 2C illustrates an exemplary schematic of another 3-channel microfluidic intercellular communication analysis device. FIG. 2D illustrates an exemplary schematic of yet another 3-channel microfluidic intercellular communication analysis device. FIG. 2E illustrates various inlet and outlet design of the cell channels and respective aggregation of the cells therein. FIG. 2F illustrates various cell channel designs and respective cell aggregation therein.

FIGS. 3A-3B illustrate images of intercellular communications of the EVs and/or soluble factors via Matrigel-infused matrix channel and PEDGA-infused matrix channel according to non-limiting, example embodiments of the disclosed concept.

FIG. 4 illustrates selective hydrophobization of a matrix channel of an exemplary microfluidic intercellular communication analysis device, using a plasma pulse and an electrode for directed plasma activation according to a non-limiting, example embodiment of the disclosed concept.

FIGS. 5A-5C illustrate characterization of particle diffusion according to a non-limiting, example embodiment of the disclosed concept.

FIGS. 6A-6D illustrate exosome diffusion across a Matrigel-infused matrix channel and uptake by recipient cells in a recipient channel according to non-limiting, example embodiments of the disclosed concept.

FIGS. 7A-7C illustrate generation of a stable U937 cell line for the production of fluorescently tagged EVs according to a non-limiting, example embodiment of the disclosed concept.

FIGS. 8A-8E illustrate live EV exchange on the microfluidic intercellular communication analysis device according to a non-limiting, example embodiment of the disclosed concept.

FIG. 9 is a flow chart for a method of analyzing intercellular communication of target EVs, particles or protein using a microfluidic intercellular communication analysis system of FIG. 1.

FIGS. 10A-10D illustrate improved cell injection and extraction methods according to a non-limiting, example embodiment of the disclosed concept. FIG. 10A illustrates cell injection using a syringe pump. FIG. 10B illustrates cell injection via gravity transfer using a pipette.

FIG. 10C illustrates cell extraction method using a pipette. FIG. 10D illustrates an exemplary pipette.

FIG. 11 illustrates puromycin kill curve for U937 cells according to a non-limiting, example embodiment of the disclosed concept.

FIGS. 12A-12B illustrate U937-XP cell line generation according to a non-limiting, example embodiment of the disclosed concept FIG. 12A shows a flowthrough diagram of the protocol used for generation of U937-XP. FIG. 12B shows fluorescent images of cells transduced at different MOIs obtained using GFP emission filter (original magnification: 40×).

FIG. 13 illustrates size characterization of U937 and U937-XP exosomes according to a non-limiting, example embodiment of the disclosed concept.

FIG. 14 illustrates various EV subtypes and particles and their sizes.

### DETAILED DESCRIPTION

While the general inventive concepts are susceptible of embodiment in many forms, there are shown in the drawings, and will be described herein in detail, specific embodiments thereof with the understanding that the present disclosure is to be considered an exemplification of the principles of the general inventive concepts. Accordingly, the general inventive concepts are not intended to be limited to the specific embodiments illustrated herein.

It is also to be understood that the terminology used herein is for the purpose of describing particular embodiments only, and is not intended to be limiting.

The articles “a” and “an” are used herein to refer to one or more than one (i.e., to at least one) of the grammatical object of the article. By way of example, “a cell” means one cell or more than one cell.

“About” as used herein when referring to a measurable value such as an amount, a temporal duration, and the like, is meant to encompass variations of ±5%, preferably ±1%, and still more preferably ±0.1% from the specified value, as such variations are appropriate to perform the disclosed methods.

As used herein, the term “nanoscale” means particles having a size range between approximately 1 and 100 nanometers (nm).

As used herein, the term “nanometer” means 1/1,000,000,000 meter (m).

As used herein, the term “sub-micronscale” means particles having a size less than a micron (μm) and larger than 100 nm.

As used herein, the term “micron” means 1/1,000,000 meter (m).

As used herein, the term “microscale” means having a size of approximately 1 to 5 microns (μm).

In some embodiments of any of the compositions or methods described herein, a range is intended to comprise every integer or fraction or value within the range.

Embodiments described herein as “comprising” one or more features may also be considered as disclosure of the corresponding embodiments “consisting of” and/or “consisting essentially of” such features.

Conventional in vitro and in vivo approaches for studying EV function depend on time-consuming and expensive vesicle purification methods to obtain sufficient vesicle populations. Further, the existence of various EV subtypes with distinct functional characteristics and submicron size makes their analysis challenging. While microfluidic technology has been extensively used to alleviate some of the challenges associated with the EV studies, current microfluidic technology is limited with regard to simulating native vesicle exchange between co-cultured cells in order to enable functional studies. Thus, there exists a critical need to develop an improved device, system or method for real-time monitoring of cell-cell communication or exchange of EVs, particles or proteins between physically separated cell populations. Example embodiments of the microfluidic intercellular communication analysis device, system and method allow such cell-cell communications through selectively permeable barriers for functional analysis or collection, including barrier types that mimic the extracellular matrix. The example embodiments of the microfluidic intercellular communication analysis device simulates the ECM-cell interplay of an in vivo environment that allows for functional studies under physiologically relevant EV production and distribution conditions, while dispensing with the tedious and lengthy EV purification procedures. The small scale of the microfluidic intercellular communication analysis device and the micro-sized channels thereof help to avoid the resource-intensive setups typically needed, requiring very few cells and only a few microliters of media volume, and permit the PDMS layers to be bonded to standard-size coverslips for simple microscope-based observation of the vesicles and cell populations. The example microfluidic intercellular communication analysis device fully integrates cell culturing with microfluidic EV manipulation to create an in vitro EV assay. Further, the microfluidic intercellular communication analysis device provides a versatile tool for researchers across multiple disciplines to perform functional EV studies under physiologically relevant conditions.

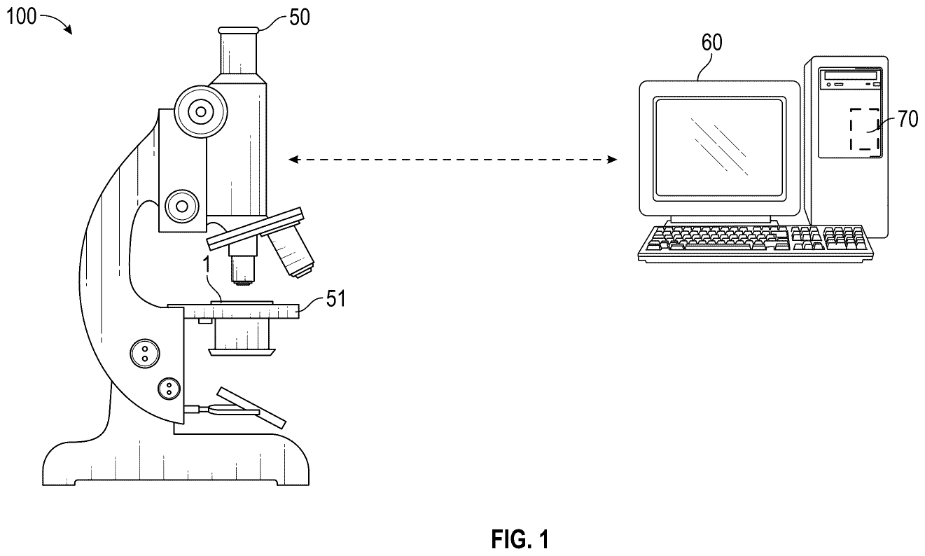

FIG. 1 illustrates a microfluidic intercellular communication analysis system 100 according to a non-limiting, example embodiment of the disclosed concept. The microfluidic intercellular communication analysis system 100 may include an imaging device 50 and a microfluidic intercellular communication analysis device 1. The imaging device 50 is couplable to the microfluidic intercellular communication analysis device and structured to provide real-time images of cell-cell communication of a target subject (e.g., without limitation, exosomes, other EVs, particles, protein, et.) within the microfluidic intercellular communication analysis device 1. The imaging device 50 may be any type of high-resolution microscopes, cameras or any other appropriate image capturing devices. A high-resolution microscope includes a reception area structured to receive and hold the microfluidic intercellular communication analysis device 1 for a period (e.g., without limitation, a day, several days, etc.). The period may be determined for specific needs of an investigator, researcher, analyst, etc. A camera may be disposed above the microfluidic intercellular communication analysis device 1 and structured to capture intercellular communication of the target subject over the period.

In operation, a user (e.g., researcher, analyst, investigator, etc.) may place the microfluidic intercellular communication analysis device 1 on a stage 51 of the microscope 50 for review and analysis of the cell-cell communication. In some examples, the imaging device 50 may be communicatively coupled to a workstation 60 including an imaging software 70 (e.g., without limitation, Nikon's NIS-Elements) for remote viewing and monitoring of the cell-cell communication of the target subject within the microfluidic intercellular communication analysis device 1, uploading of images of the cell-cell communication and/or storing the images. The imaging software 70 may automatically and continuously acquire images of the cell-cell communication of the target subject within the microfluidic intercellular communication analysis device 1 and analyze the cell-cell communication over a period (e.g., without limitation, hours, days, weeks, etc.). The period may be determined for specific needs of an investigator, researcher, analyst, etc. The imaging software 70 may be uploaded from a cloud (not shown), a flash drive, or a shared network drive and stored in the controller or memory (not shown) of the work station 60. The controller may be, for example and without limitation, a microprocessor, a microcontroller, or some other suitable processing device or circuitry. The memory, which can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. In some examples, the user may create or reconfigure a set of instructions for the imaging software 70 via a user interface of the workstation 60 in order to adjust and/or control viewing parameters within the microfluidic intercellular communication analysis device 1.

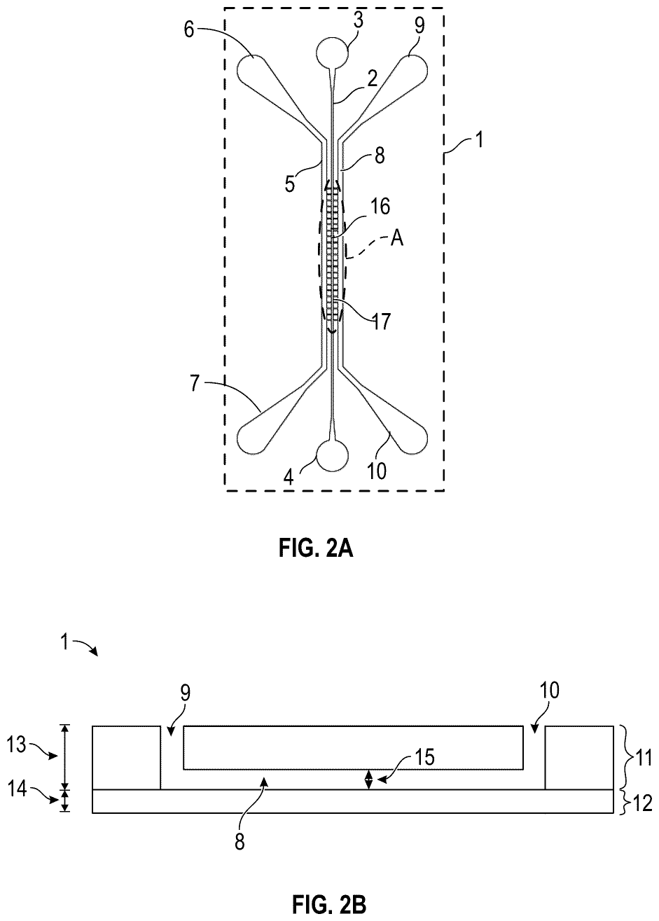

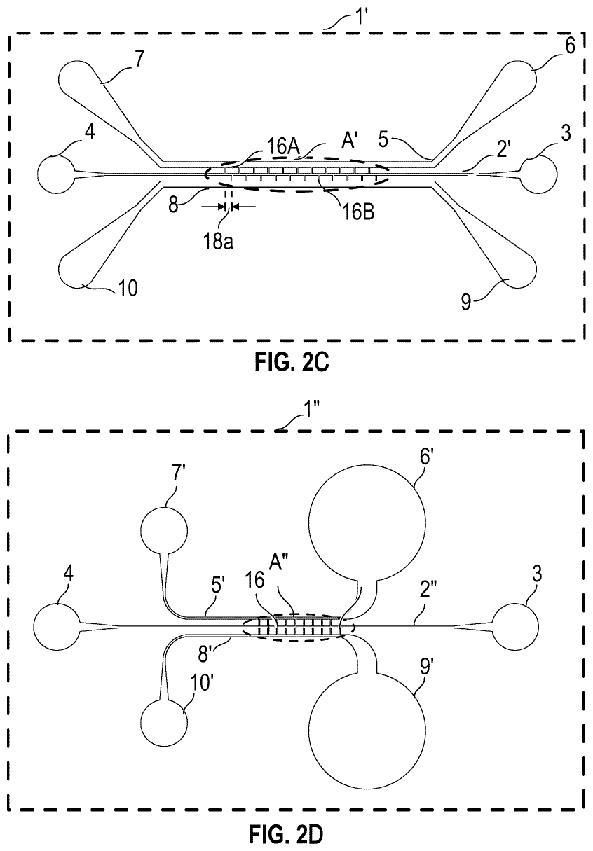

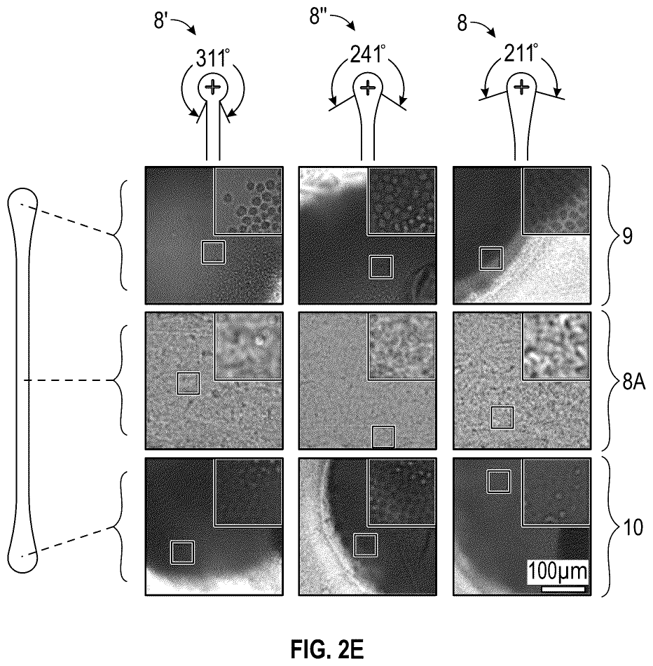

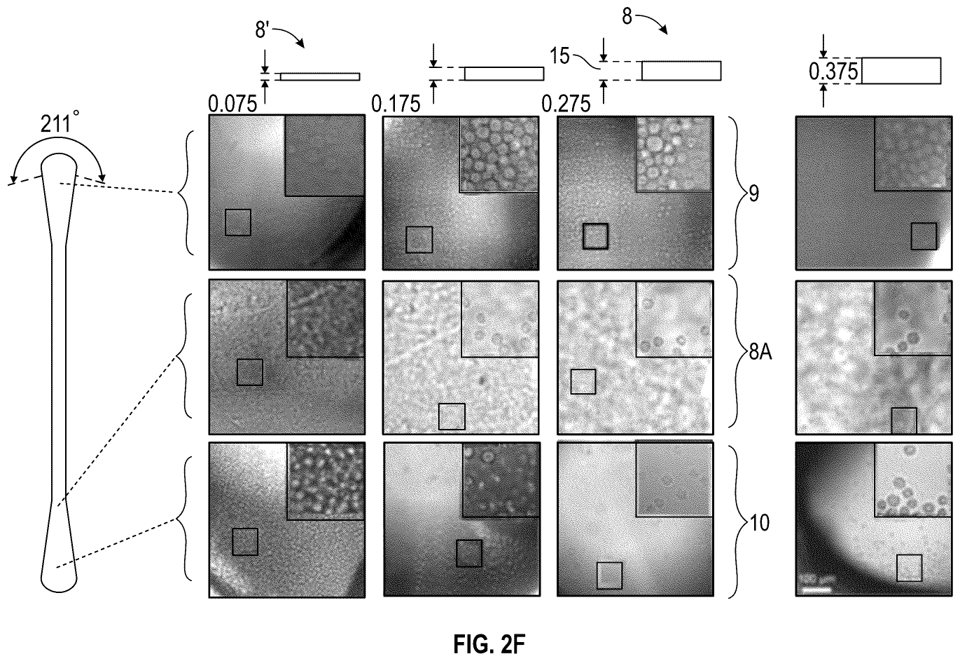

FIGS. 2A-4 illustrate schematics of an exemplary microfluidic intercellular communication analysis device 1 according to non-limiting, example embodiments of the disclosed concept. The microfluidic intercellular communication analysis device 1 includes a coverslip 12 and a polydimethylsiloxane layer 11 attached (e.g., without limitation, plasma-activated, and then thermally bonded) on upper surface of the coverslip 12 as shown in FIG. 2B. Polydimethylsiloxane (PDMS), also known as dimethylpolysiloxane or dimethicone, is classified as a silicone polymer and can be utilized for a variety of purposes such as industrial lubrication or biomaterial application. The chemical formula of PDMS is CH₃[Si(CH₃)₂O]ₙSi(CH₃)₃, where n is the number of repeating monomer [Si(CH₃)₂O] units. It has become popular in biomedical applications due to its properties including physiological indifference, chemical inertia and stability, resistance to biodegradation, resistance to different temperatures after curing, biocompatibility, gas permeability, optical transparency and simple fabrication by replica molding. It has been widely utilized in micropumps, catheter surfaces, dressings and bandages, microvalves, drug delivery vehicles, optical systems, in vitro study of diseases, implants, photonics, and microfluidics. The PDMS layer 11 includes a plurality of microfabricated, microfluidic channels 2, 5, 8 imprinted on its surface, each channel having an inlet 3, 6, 9 and an outlet 4, 7, 10. The PDMS layer 11 is degassed before curing by placing the layer in a vacuum chamber, thereby removing the gas bubbles in the PDMS. PDMS is a gas diffusible substrate, allowing for the exchange of gas molecules such as carbon dioxide and oxygen. While FIG. 2B only shows a recipient cell channel 8 imprinted on the PDMS layer 11, it is to be understood that the donor cell channel 5 as well as the matrix channel 2 are also disposed in the PDMS layer 11.

The coverslip 12 has a thickness 14 of, e.g., without limitation, approximately 0.1 mm˜0.2 mm. This is advantageous in that it allows for a better visualization of the cell-cell communication of the target subject as compared to conventional microfluidic devices including a thicker glass layer (typically, 1 or 2 mm in thickness) attached to the PDMS layer. Due to extremely thin distance required between the microfluidic intercellular communication analysis device 1 and the imaging device for effective viewing (e.g., without limitation, 100× oil objective) of the target subject, the glass layer having 1-2 mm thickness is not practicable for such 100× objective viewing. As such, the coverslip 12 having a much smaller thickness than that of conventional glass layers is utilized to allow the required 100× oil objective viewing via the imaging device 50, thereby providing accurate visualization of intercellular communications of the EVs and/or particles.

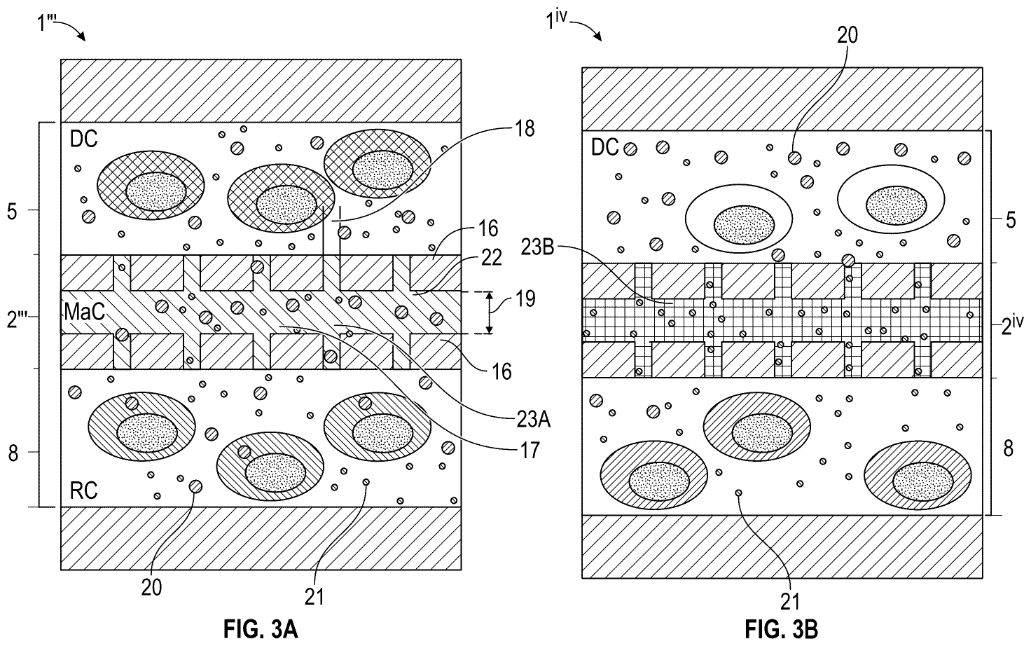

The microfluidic intercellular communication analysis device 1 includes a plurality of microfluidic channels 2, 5, 8 each having an inlet 3, 6, 9 and an outlet 4, 7, 10 (24, 25) as shown in FIG. 2A. The plurality of microfluidic channels 2, 5, 8 are disposed within the PDMS layer 11 and include a donor cell channel 5, a recipient cell channel 8, and a matrix channel 2 therebetween as shown in FIGS. 2A, 3A-B and 4. As such, the microfluidic intercellular analysis device 1 includes two cell channels 5, 8 with a single matrix channel 2 separating the two cell channels 5, 8 without additional control or condition channels as required by the conventional microfluidic devices (24, 25). In some examples, one or more accessory channels may be included in the microfluidic intercellular communication analysis device 1 for analyzing different intercellular communication aspects. In some examples, more than one matrix channel 2 may be included in the microfluidic intercellular communication analysis device 1 based on the subject of investigation. In some examples, more than one donor cell channel and/or more than one recipient cell channel may be included in the microfluidic intercellular communication analysis device 1 as needed or desired. All channels are sufficiently distanced from one another so as to prevent the inlets 3, 6, 9 and the outlets 4, 7, 10 from overlapping one another.

The donor cell channel 5 is structured to receive a donor cell population (e.g., without limitation, a U937-XP cell population) via the inlet 6. The recipient cell channel 8 is structured to receive a recipient cell population (e.g., without limitation, a U937 cell population) via the inlet 9. The donor cell channel 5 and the recipient cell channel 8 have lengths of, e.g., without limitation, 19 mm and 16 mm, respectively. The donor cell channel 5 and the recipient cell channel 8 may have either the same lateral width or different lateral widths. For example, both cell channels 5, 8 may have the same width of, e.g., 200 μm, 500 μm, etc., depending on the type and/or size of the target subject. For example, the larger cell channel width allows for investigation of the cell migration between the cell channels.

The matrix channel 2 is partly coupled to a part of the donor cell channel 5 and a part of the recipient cell channel 8 (25). The matrix channel 2 includes two arrays of a plurality of transversely spaced-apart matrix ribs 16 and a main diffusion barrier reservoir 17 transversely running between the two arrays as shown in FIGS. 3A-3B. The matrix channel 2 is structured to receive a diffusion barrier 22, including a type that is structured to mimic an extracellular matrix, via an inlet 3 and conduit the target subject to pass from the donor cell channel 5 to the recipient cell channel 8 via pores thereof. The diffusion barrier 22 includes a hydrogel (e.g., without limitation, Matrigel 23A, PEGDA 23B, etc.). The matrix ribs 16 are transversely spaced-apart from one another (25) by a distance 18 of, e.g., without limitation, approximately 15 μm, and the main diffusion barrier reservoir 17 has a lateral width 19 of, e.g., without limitation, approximately 50 μm. The distance 18 is substantially smaller than the width 19 of the main diffusion barrier reservoir 17 so as to allow capillary action for facilitating the injection of the barrier 22 into the matrix channel 2 while the surface tension at the open end (i.e., the outlet 4) prevents the hydrogel from leaking into the donor cell channel 5 and/or the recipient cell channel 8. As such, the selective loading of matrix channel 2 with the hydrogel 22 is achieved by balancing the hydrodynamic pressure and surface tension of the hydrogel 22.

Specific improvements to the microfluidic intercellular communication analysis device 1 are discussed in detail now. First, the PDMS layer 11 has been optimized to have a thickness 13 of, e.g., without limitation, 3-4 mm in order to address breakage of the thin coverslip 12. It has been shown that the 3-4 mm thickness of the PDMS layer 11 effectively prevents bending of the microfluidic intercellular communication analysis device 1 upon attaching the PDMS layer 11 to the coverslip 12. Further, for proper bonding, the PDMS layer 11 may be cleaned in order to remove all PDMS debris that may interfere with the bonding to the coverslip 12 with, e.g., without limitation, ethanol, instead of conventionally used isopropyl alcohol to lessen the PDMS becoming brittle after drying with air flow. Further, in order to strengthen the bonding, the surfaces of the PDMS layer 11 and the coverslip 12 may be plasma-activated (i.e., covalent-bonded) and then thermally bonded. A handheld corona treater can be used to plasma-activate the surfaces with settings at its maximum output voltage (e.g., without limitation, approximately 45 kV) for a short period (e.g., without limitation, less than 5 s). The activated PDMS layer 11 may then be placed on the activated coverslip 12 and air bubbles therebetween may be removed.

In addition, the donor cell channel 5 and the recipient cell channel 8 have been optimized to reduce or prevent cell aggregations in the inlets 6, 9, the outlets 7, 10 and channel pathways therebetween as shown in FIGS. 2E-2F. While FIGS. 2E-2F show optimization of the recipient cell channel 8 only, it is to be understood the same optimizations are made to the donor cell channel 5 also for the same purposes. FIG. 2E shows optimization of a recipient cell channel. The recipient cell channels 8, 8′,8″ each have different arc angles for respective inlets and outlets, each pair of respective inlet and outlet having the same arc angle. The recipient cell channel 8′ is a conventional recipient cell channel with a pair of inlet and outlet having an arc angle of 311° (25). As shown in FIG. 2E, a large number of cells are aggregated in such cylindrical shaped inlet and outlet as well as within the channel surface within the recipient cell channel 8′. Such aggregation leads to overcrowding and cell starvation, negatively impacting the analysis of intercellular communication. The recipient cell channel 8″ has been modified to include a pair of inlet and outlet having a widened arc angle of 241° and less cell aggregation within the inlet, outlet and the channel 8″ has been observed as compared to the aggregation in the conventional recipient cell channel 8′. When the arc angle of the inlet and outlet is further widened to 211° as in the recipient cell channel 8, little or no cell aggregation is observed within the inlet 9, the outlet 10 and the channel surface 8A as shown in FIG. 2E. Accordingly, the microfluidic intercellular communication analysis device 1 includes the cell channels 5, 8 having the optimized arc angle ranging, e.g., without limitation, from 180° to 300°.

Further, cell channel height 15 may be increased so as to reduce or prevent cell aggregation in the inlet 9, the outlet 10, and the channel surface 8A as shown in FIG. 2F. The conventional recipient cell channel 8′ having the height of, e.g., 75 μm (25) suffers a significant number of cells aggregated within channel surface and the outlet of the recipient cell channel 8′. With an increased height of 175 μm, cell aggregations in the channel surface and the outlet are decreased. With an even more increased height of 275 μm, little or no cell aggregation occurred in the channel surface 8A and the outlet 10 of the recipient cell channel 8. When the height is further increased beyond 275 μm, decreased cell aggregations (as compared to those at the height of 75 μm) in the channel surface and the outlet thereof are observed. Thus, the cell channels 5, 8 of the microfluidic intercellular communication analysis device 1 have the optimized height 15 ranging from 200 μm to 400 μm.

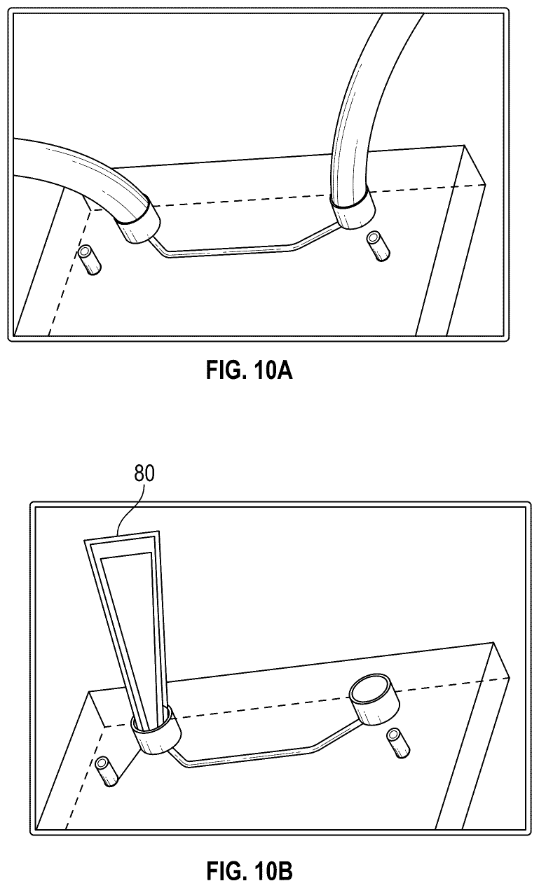

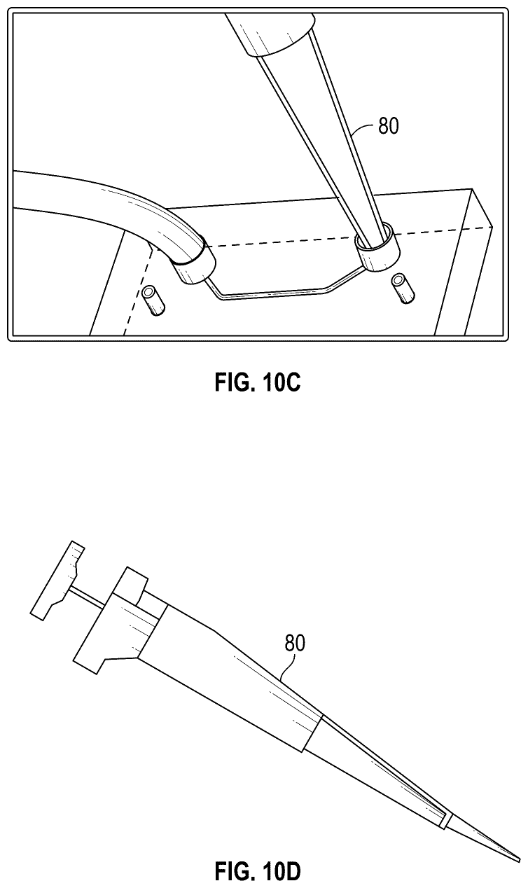

Additionally, the inlets 6, 9 and the outlets 7, 10 of the cell channels 5, 8 may be further optimized to have 21 gauge, which is smaller than the inlet/outlet gauge (e.g., typically, 18 gauge) of the cell channels in the conventional microfluidic devices. The smaller gauge allows a more controlled injection of cell populations into the cell channels 5, 8. For example, in an example of pipette or syringe pump injection, the smaller gauge allows for a tighter seal over the tip of the pipette or syringe tubing (see FIGS. 10A-10B).

Furthermore, the matrix channel 2 of the microfluidic intercellular communication analysis device 1 has also been optimized. For example, the inlet 3 and the outlet 4 of the matrix channel 2 may have a 16 gauge circumference. As such, the inlet 3 and outlet 4 of the matrix channel 2 are larger than the matrix channel inlets and outlets (e.g., typically, 18 gauge) of the conventional microfluidic devices (25) so as to allow for a larger pool of hydrogel injected within the matrix channel 2 than is allowed in the matrix channels of the conventional microfluidic device.

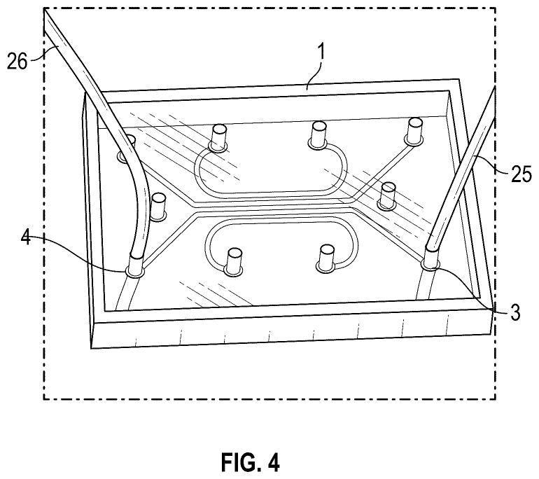

Moreover, activating the matrix channel 2 has also been optimized by selectively activating via directed plasma pulsation to further improve hydrogel-PDMS interaction and enhance the matrix channel's hydrophilicity and bonding to the coverslip 12. First, the microfluidic channels 2, 5, 8 may be rendered hydrophobic by heating the devices at a temperature ranging from 180° C. to 250° C. for a period ranging from 60 minutes to 70 minutes. Advantageously, the 1-hour hydrophobization significantly reduces the time (e.g., without limitation, 24-hours or overnight at 70° C.) required to hydrophobize the PDMS by the conventional microfluidic devices (24, 25). The matrix channel 2 is then selectively made hydrophilic by directed plasma-activation from a handheld corona treater for efficient hydrogel infusion therein as shown in FIG. 4. The hydrogel infusion may be further augmented by temporarily placing a ground electrode (e.g., without limitation, a copper wire) 26 at the outlet 4 while a metal tip 25 of the corona treater is placed within the inlet 3 and applying the plasma pulse to the matrix channel 2. All other inlets 6, 9 and outlets 7, 10 are blocked in order to allow an electric pulse of sufficient power (e.g., approximately 45 kV) to be used without the pulse spreading into the cell channels 5, 8. The spreading of the electric pulse beyond the transversely spaced-apart matrix ribs 16 would activate the adjacent cell channels 5, 8, thereby causing the hydrogel injection to leak beyond the matrix channel 2. By placing an electrode 26 at the outlet 4 while the plasma pulse is being applied to the matrix channel 2 from the metal tip 25 of the corona treater at the inlet 3, the plasma pulse travels directly to the electrode with minimal leakage into cell channels, thus allowing the plasma pulse to be directed through the matrix channel 2 specifically. Such selective activation with directed plasma pulsation using a corona treater combined with an electrode is novel.

In some examples, the matrix channel 2′ is modified for improved optimization of hydrogel loading. As shown in FIG. 2C, the spaced-apart matrix ribs 16 within the matrix channel 2′ are offset with respect to one another. That is, one array 16A of the spaced-apart matrix ribs 16 are offset from the other array 16B of the spaced-apart matrix ribs 16 by a distance 18a (e.g., without limitation, ranging from 50-200 μm). The offset improves the barrier injection by, e.g., without limitation, decreasing surface tension at each ribbed intersection within the matrix channel 2′, thereby allowing a more uniform and easier flow of the hydrogel into the matrix channel as compared to the flow provided by transversely aligned spaced-apart matrix ribs.

In some examples, the donor cell channel inlet and the recipient cell channel inlet are modified for performing tissue or organoid studies. As shown in FIG. 2D, the inlets 6′, 9′ of the donor cell channel 5′ and the recipient cell channel 8′ have a larger gauge (e.g., without limitation, 8 to 12 gauge diameter) than the inlets and outlets 6, 9, 7, 10 of the cell channels shown in FIG. 2A such that larger target subjects such as tissue or organoids can be easily inserted into the donor channel inlet 6′ or the recipient channel inlet 9′. Further, the spaced-apart matrix ribs 16 are disposed closer towards the inlets 6′, 9′ of the donor cell channel 5′ and the recipient cell channel 8′ such that the target subjects (e.g., EV, protein, particle, nucleic acid) are diffusing closer to the recipient cell channel inlet 9′.

Additionally, the microfluidic intercellular communication analysis device 1 advantageously allows selection of target EVs and/or soluble factors based on pore sizes of hydrogels 22 to be infused in the matrix channel 2. FIGS. 3A-3B show selective selection of target EVs or particles based on different pore sizes of hydrogels being used. FIG. 3A shows intercellular communication of target EVs 20 and/or soluble factors 21 between the donor cell channel 5 and the recipient cell channel 8 when Matrigel 23A is used as the diffusion barrier for the matrix channel 2′″ of the microfluidic intercellular communication analysis device 1′″. FIG. 3B shows intercellular communication of target EVs 17 and/or soluble factors 18 when PEGDA gel 23B is used as the diffusion barrier for the matrix channel 2^{iv} of the microfluidic intercellular communication analysis device 1^{iv}. As shown in FIGS. 3A-B, the matrix channel 2′″, 2^{iv} can be filled with either Matrigel 23A or PEGDA 23B to permit size-based diffusion of either EVs and/or soluble factors. Due to Matrigel 23A having larger pores than those of PEGDA gel 23B, the target EVs 20 as well as the soluble factors 21 are able to cross over from the donor cell channel 5 into the recipient cell channel 8 via the Matrigel-infused matrix channel 2′ while only the soluble factors 21 are able to cross over from the donor cell channel 5″ into the recipient cell channel 8 via the matrix channel 2^{iv} infused with PEGDA gel 23B. As such, the microfluidic intercellular communication analysis device 1,1′″,1^{iv} according to the disclosed concept allows injection of a variety of hydrogels with different pore sizes that prevent passive cell migration and grant control of the sized-based particle diffusion selection. Further, the use of multiple different hydrogels instead of using only Matrigel (25 using only Matrigel) with otherwise the same experimental parameters allows for size selection of particles that can diffuse across the hydrogel, which then allows determining the population of particles that exert observed functional effects. This is useful for studying different-sized EV populations, or to block EV migration altogether, so as to distinguish functional effects of target EVs 20 from soluble-factor-mediated effects.

The optimization and fabrication of the microfluidic intercellular communication analysis device 1 as well as other pertinent description (e.g., cell media preparation, etc.) are described further in the Materials and Methods section. Hereinafter, the microfluidic intercellular communication analysis device 1 or its component thereof (e.g., the PDMS layer 11) may also be referred to as “chip”.

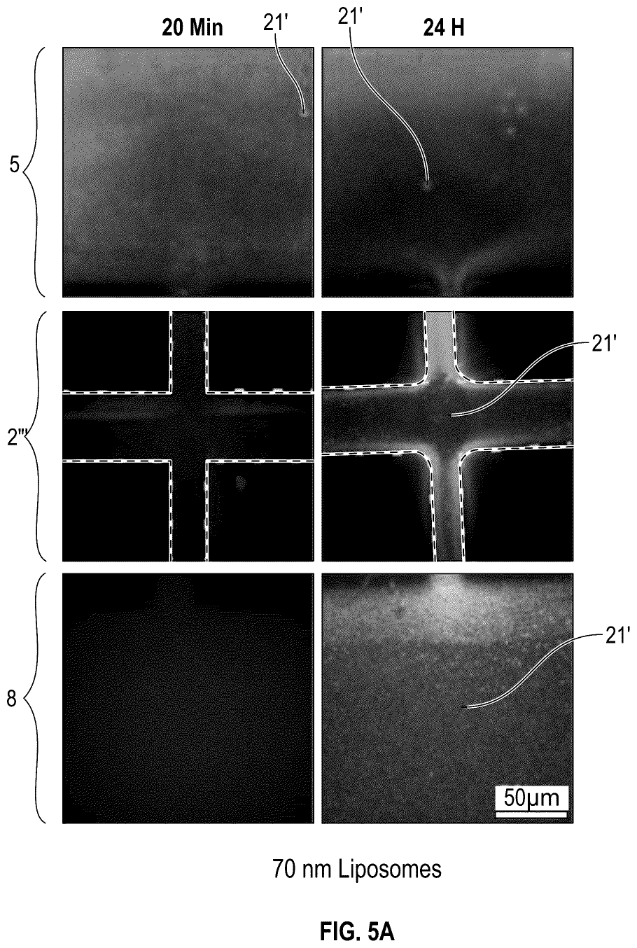

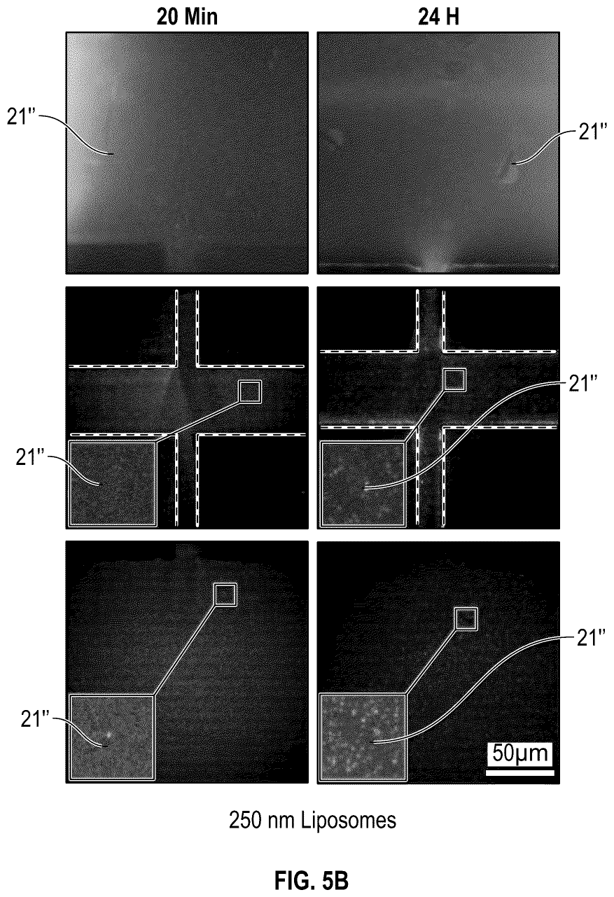

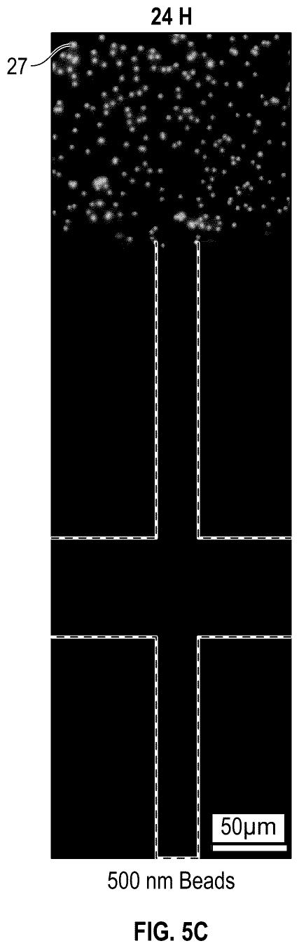

FIGS. 5A-8E illustrate various experiments performed using the microfluidic intercellular communication analysis system 100.

### Example 1: Matrigel Diffusion Characterization

FIGS. 5A-5C show diffusible target EVs and/or particle size profile of Matrigel according to a non-limiting, example embodiment of the disclosed concept. The size selectivity of Matrigel at 8 mg/mL was tested by diffusion of different-sized particles. A Matrigel-loaded microfluidic intercellular communication analysis device 1′″ was injected in their donor channels 5 with 70 nm (FIG. 5A), 250 nm DOPE-PEG(2000)-N-Cy5-labelled liposomes (FIG. 5B), and 500 nm Fluoresbrite® (Polysciences, Warrington, PA, USA) yellow-green fluorescing polystyrene beads (FIG. 5C), presented as a false-color image for consistency with panels. The microfluidic intercellular communication analysis devices 1′″ were visualized at 20 min and 24 hour after the liposome injection, using Cy5 (FIGS. 5A-5B) or GFP emission filters (FIG. 5C) to confirm particle diffusion from the donor channel 5 across the matrix channel 2′″ and into the recipient channel 8. The Matrix channel ribs 16 are outlined with dashed lines. Insets are shown within solid-outlined inner boxes within the matrix channel 2′″ and the recipient cell channel 8. The insets have a width of 10.80 μm.

In order to determine the effective diffusible particle size profile of Matrigel at working concentration of 8 mg/mL, diffusion of different-sized fluorescent particles 21′ across the matrix channel 2′″ was imaged real-time. The effective pore size for Matrigel has been previously shown to be approximately 140 nm, ranging to upwards of 350 nm (28). Liposomes were used to mimic diffusion of EVs across the Matrigel, which can be prepared to have specific diameter ranges. Liposomes fluorescently labeled with Cy5 were prepared by extrusion to produce monodisperse population sizes of 70 nm 21′ and 250 nm 21″ as shown in Table 1 below. Table 1 enumerates measured sizes of liposome preparations. The average diameters of 70 nm and 250 nm Cy5-liposome preparations measured using DLS are utilized. Table 1 lists the diameter and polydispersity (PDI) measurements for 2 independent readings and the mean values for each preparation.

TABLE 1

| Sample | Diameter (in nm) | PDI |
|---|---|---|
| 70 nm Liposomes 1 | 72.49 | 0.027 |
| 70 nm Liposomes 2 | 72.10 | 0.046 |
| 70 nm Liposomes 3 | 70.55 | 0.046 |
| 70 nm Liposomes Mean | 71.71 | 0.040 |
| 250 nm Liposomes 1 | 249.90 | 0.281 |
| 250 nm Liposomes 2 | 258.20 | 0.294 |
| 250 nm Liposomes 3 | 246.10 | 0.307 |
| 250 nm Liposomes Mean | 251.40 | 0.294 |

The liposome solutions were then manually injected into the donor cell channel 5. Diffusion of the liposomes 21′, 21″ was imaged and compared between post-injection time points of 20 min and 24 hour after the injection of the liposomes 21′, 21″. Both liposome populations 21′, 21″ were able to diffuse through within the 24 hour period. As expected due to their smaller size, the 70 nm vesicles 21′ diffused through more rapidly than the 250 nm ones 21″ when compared at the 24 hour time points as shown by the diffused liposomes 21′, 21″ in the recipient channel 8′. To find an upper limit of the diffusion profile, 500 nm yellow-green fluorescing polystyrene beads 27 were also injected into the donor channel 5 of the Matrigel-loaded microfluidic intercellular communication analysis device 1′″, and the diffusion was imaged again at 20 min and 24 hour time points. There was no observed diffusion of the beads 27 even at the 24 hour time point as shown in the recipient channel 8′ of FIG. 5C. Therefore, it has been shown that vesicles with diameters of at least 250 nm, but less than 500 nm, can pass through Matrigel. This should allow diffusion of exosomes and other smaller EVs, but prevent the crossing of larger biological particles, such as apoptotic bodies, larger microvesicles and oncosomes, or the passage of bacteria and cells (29-31). The concentration of the Matrigel or other hydrogels that can be used, can be adjusted for size selection of the target object that can pass through such that various EV subtypes, or alternatively soluble factors (e.g., without limitation, proteins, nucleic acids, proteins in complex with nucleic acids, etc.) are selectively allowed to cross the hydrogel barrier to migrate from one cell channel to another.

### Example 2: Exosome Diffusion in the Microfluidic Chin

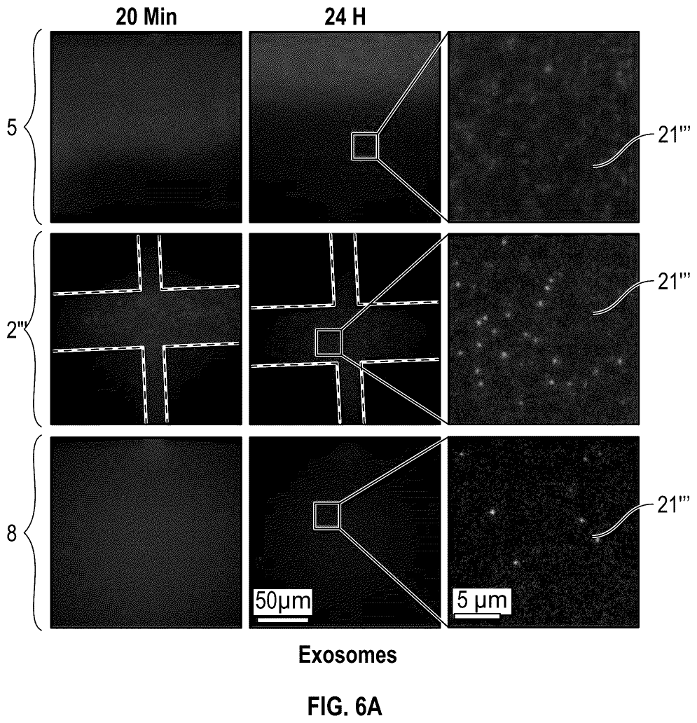

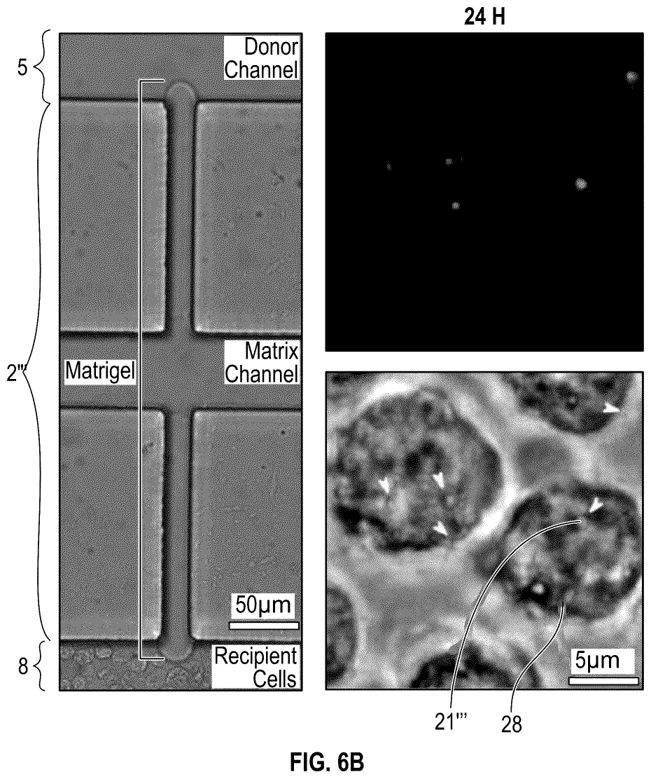

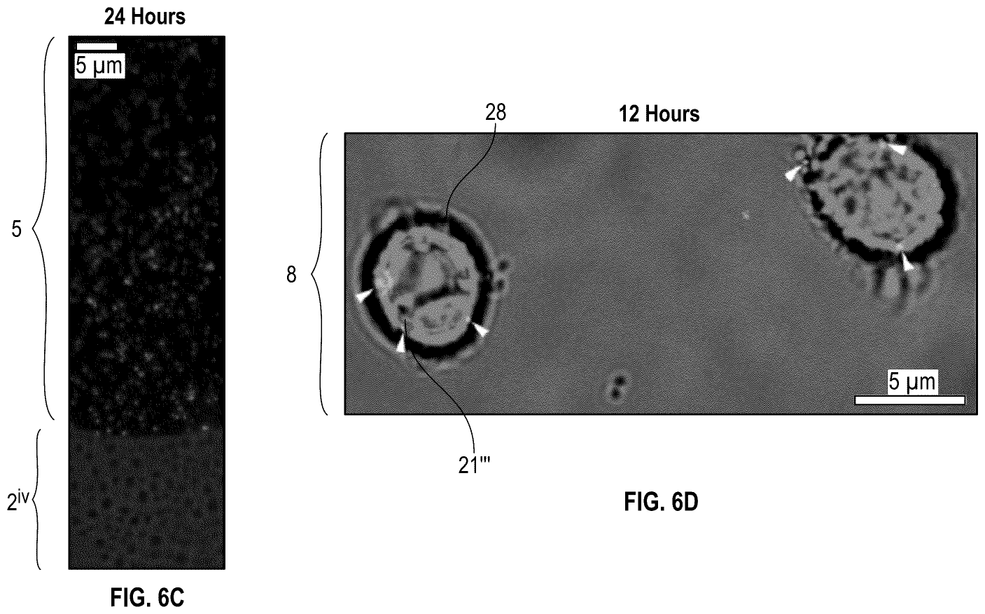

FIGS. 6A-D illustrate exosome diffusion in the microfluidic intercellular communication analysis device 1, 1′″, 1^{iv} according to a non-limiting, example embodiment of the disclosed concept. The ability to observe and investigate exosomes using the Matrigel-infused chip assays was confirmed by demonstrating diffusion of labelled exosomes across the Matrigel into recipient cells. In FIG. 6A, a Matrigel-loaded microfluidic intercellular communication analysis device was injected with DOPE-PEG(2000)-N-Cy5-labelled U937 exosomes into the donor channel. The donor channel 5, matrix channel 2′″, and recipient channel 8 were visualized at 20 min and 24 hour after injection, using a Cy5 emission filter to observe exosome diffusion. The matrix channel ribs are outlined with dashed lines. Insets are shown within the inner boxes in the channels. The insets were contrast-enhanced for visual clarity. Original magnification=1000×. In FIG. 6B, a Matrigel-loaded microfluidic intercellular communication analysis device 1″ was injected with DOPE-PEG(2000)-M-Cy5-labelled U937 exosomes in the donor channel and recipient U937 cells in the recipient channel. The microfluidic intercellular communication analysis devices were visualized at 24 hour after injection using bright-field and Cy5 emission filters showing no cell migration through the Matrigel and uptake of exosomes by recipient cells (arrowheads in FIG. 6B point at imaged exosomes that are either inside the cells or are interacting with the cells on the surface). Original magnification=1000×. FIG. 6C illustrates PEGDA hydrogel interface prevents diffusion of exosomes. The inability of exosomes to pass through PEGDA at 1.2 nm in diameter was verified using PEGDA-loaded chips that were injected with DOPE-PEG(2000)-N-Cy5 labelled U937 exosomes and visualized after 24 hours at the interface between the exosome-injected donor channel (Bottom) and the PEGDA filled matrix channel using Cy5 emission filter (original magnification: 1000×). FIG. 6D illustrates verification of exosome uptake into recipient cells at 12 hours. The exosome uptake by cells in the Matrigel-infused microfluidic intercellular communication analysis device assays was confirmed by demonstrating diffusion of labelled exosomes across the Matrigel and subsequent uptake into recipient cells. A Matrigel chip 1′″ was injected with DOPE-PEG (2000)-N-Cy5 labelled U937 exosomes in the donor channel and recipient U937 cells in the recipient channel 8. The microfluidic intercellular communication analysis devices 1 were visualized at 12 hours post injection using Brightfield and Cy5 emission filters, demonstrating uptake of exosomes by the recipient cells (arrowheads point at imaged exosomes that are either inside the cells or are interacting with the cells on the surface. Original magnification: 1000×).

As shown in FIGS. 6A-6B, exosomes 21′″ can diffuse from the donor cell channel 5, 5′ to the recipient cell channel 8, 8′ and be subsequently taken in by the recipient cells. Monocytic U937 cells had been used during extensive mechanistic studies of how exosomes regulate innate immune responses to infection, e.g., (4). Hence, monocytic U937 cell line was used to verify EV diffusion characterization in the microfluidic intercellular communication analysis device 1, 1′″, 1″. First, exosomes 21′″ were recovered from U937 cells. After labelling with Cy5 fluorescent lipids, the exosomes 21′″ were then purified using the density gradient procedure, which is detailed in the Materials and Methods section below. Purified, labeled exosomes 21′″ were then injected into the donor cell channel 5 of the Matrigel-loaded microfluidic intercellular communication analysis device 1″, and the microfluidic intercellular communication analysis device 1″ was imaged at 20 min and 24 hour time points after the exosome injection as shown in FIG. 6A. Successful diffusion of exosomes 21′″ was observed across the matrix channel 2′″. In FIG. 6C, the exosomes 21′″ were injected into the donor cell channel 5 of a PEGDA-hydrogel-filled microfluidic intercellular communication analysis device 1ᵢᵥ with an expected pore size of 1.2 nm (32). As expected, there was no diffusion of exosomes 21′″ into the PEGDA hydrogel matrix channel 2^{iv} after 24 hour. U937 cells were then injected into the recipient cell channel 8 of a Matrigel-infused microfluidic intercellular communication analysis device 1′″ using a syringe pump (not shown), and Cy5-labeled exosomes 2′″ were injected into the donor cell channel 5 to be diffused across the membrane. As shown in FIGS. 6B and 6D, Cy5-labeled exosome 21′″ uptake by the recipient cells 28 was observed at both 24 and 12 hour time points, respectively.

### Example 3: Fluorescent EV-Producing Stable Cell Line Generation

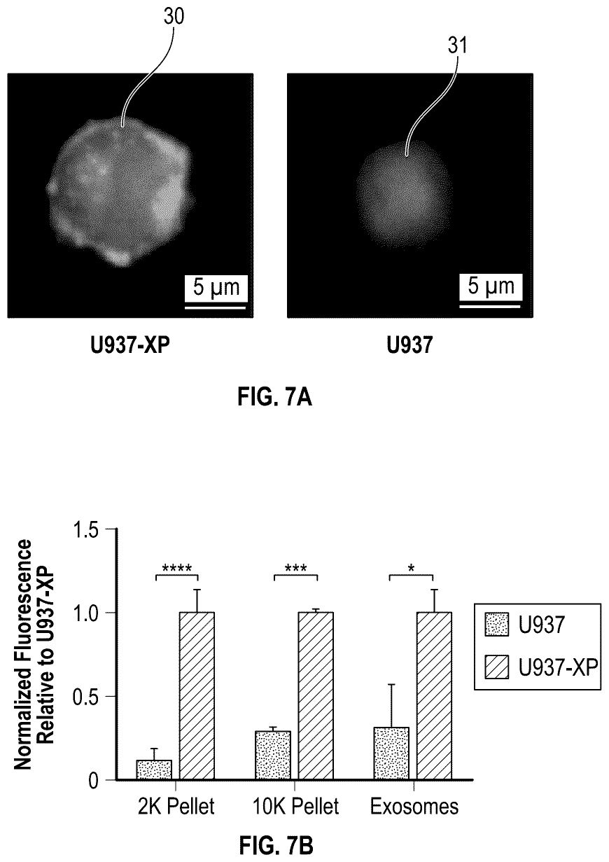

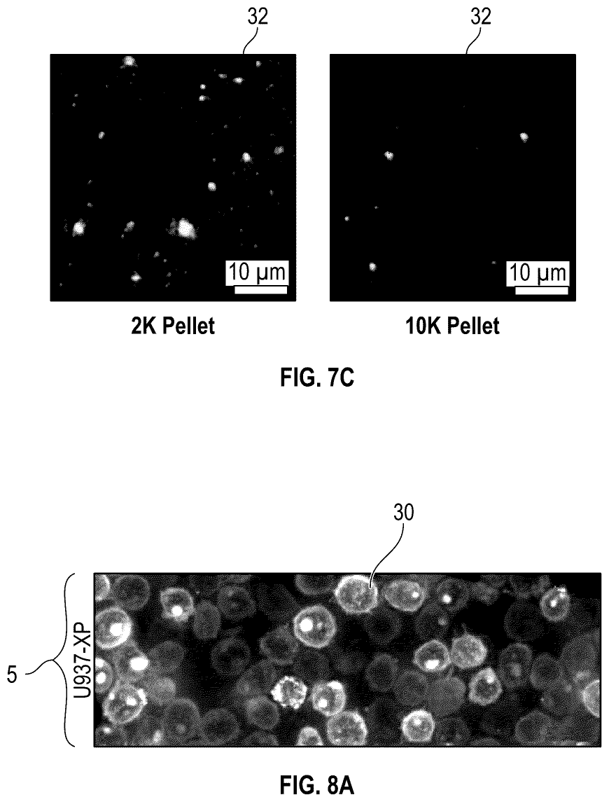

FIGS. 7A-7C illustrate diffusion of EVs produced directly from cells through the Matrigel-infused matrix channel 2′″ according to a non-limiting, example embodiment of the disclosed concept. To study live EV exchange, a stable cell line capable of producing EVs tagged with GFP for tracking live vesicle exchange on the chip was generated, using XPack lentivirus which encodes a GFP-fused peptide that targets the inner surface of EV membranes, including exosomes (33,34). The lentivirus was transduced into U937 cells 31 for production of a stable cell line (U937-XP) for the production of fluorescent EVs. Stable U937-XP clones 30 were generated by selection using puromycin treatment and identification of desirable clones based on GFP fluorescence intensity. Following expansion, the selected U937-XP clones 30 were fluorescently imaged again and compared to wild-type U937 controls 31, validating strong expression of GFP fluorescence in the U937-XP clones 30 in contrast to the background levels in control cells 31 as shown in FIG. 7A. The amount of fluorescence from vesicles 32 secreted by U937-XPs 30 was then quantified and compared to U937 vesicles.

In FIG. 7A, U937-XP and U937 cells were visualized using GFP and DAPI emission filters following fixation and mounting with DAPI-containing mounting medium (original magnification=1000×). In FIG. 7B, relative fluorescence values for vesicle populations recovered from U937 and U937-XP cells are shown. Fluorescence values show the means of 3 biological repeats for emission levels at 507 nm after excitation at 455 nm, adjusted for PBS bank and normalized relative to the mean value for U937-XP measurements (Student's i-test; *p≤0.05, ***p≤0.001, ****p≤0.0001; error bars represent standard deviation (S.D.)). FIG. 7C illustrates visualization of GFP-tagged vesicle populations in 2K and 10K pellets. U937-XP cell conditioned media was centrifuged at 2,000×g and 10,000×g to collect the 2K and 10K pellets respectively. The collected pellets, which contain a greater proportion of vesicles larger than exosomes, were imaged on glass slides using a GFP emission filter (original magnification: 1000×). Conditioned exosome-free media (EFM) from both cell lines were used to collect 2000×g pellets (2K pellets), 10,000×g pellets (10K pellets), and sucrose-gradient-purified exosomes, which are then analyzed for relative GFP emission fluorescence intensity as shown in FIG. 7B. The 2K pellet and 10K pellet vesicles were also imaged as shown in FIG. 7C. As shown in FIGS. 7B-7C, there was a significant fold increase in GFP fluorescence in each of the U937-XP vesicle populations (2K: 8.9×; 10K: 3.4×; exosomes: 3.2×), enabling fluorescence-based live observation of EV exchange (35) as expected.

### Example 4: Live EV Secretion, Diffusion, and Uptake

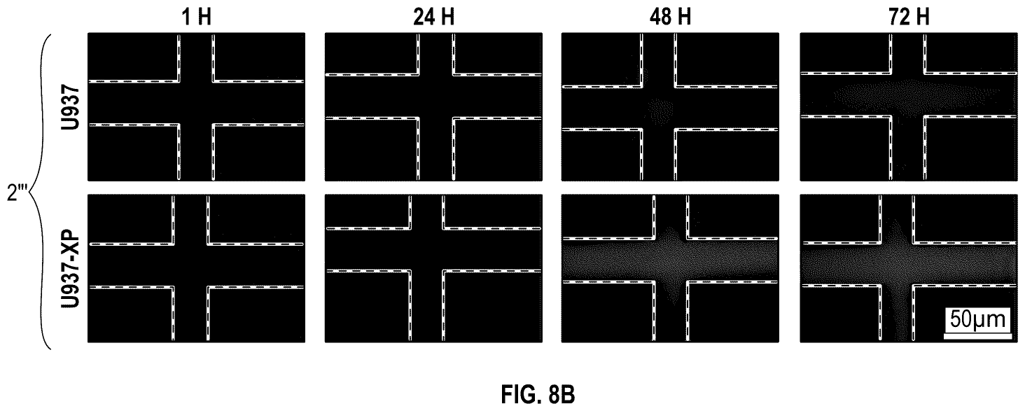

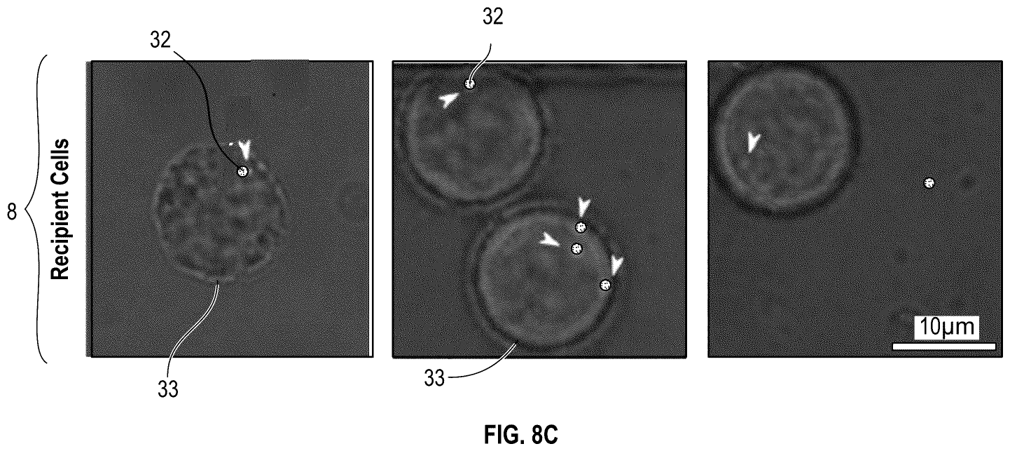

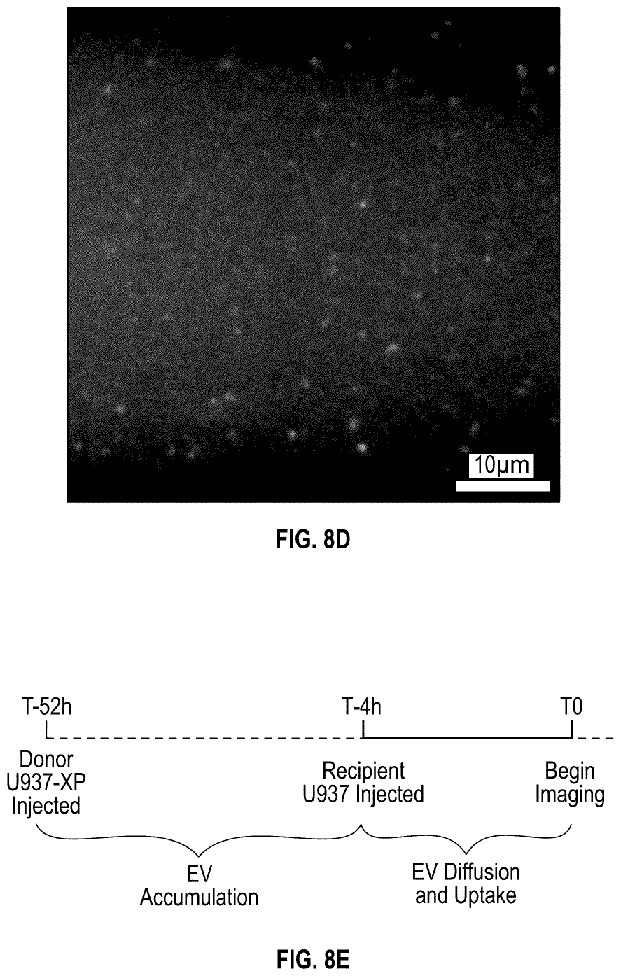

FIGS. 8A-8E illustrate live EV secretion and diffusion across a Matrigel-infused matrix channel 2′ according to a non-limiting, example embodiment of the disclosed concept. U937-XP cells were utilized for testing live EV secretion and diffusion across Matrigel along with their subsequent uptake by recipient cells. To verify the ability of the microfluidic intercellular communication analysis devices to serve as reliable platforms for live EV exchange, transmigration of secreted EVs across the Matrigel matrix channel and their internalization by cells in the recipient channel were monitored. In FIG. 8A, a Matrigel-loaded microfluidic intercellular communication analysis device 1′″ was injected in the donor cell channel with U937-XP cells, and the cells were visualized 1 hour later using a GFP emission filter (original magnification=1000×; 3D deconvoluted). In FIG. 8B, the Matrigel-loaded microfluidic intercellular communication analysis devices were injected into the donor channel with either U937-XP cells or U937 cells as a negative control, and the Matrigel-loaded matrix channel was visualized at 1 hour, 24 hour, 48 hour and 72 hour for the presence of fluorescence from diffusing vesicles using a GFP emission filter (Matrigel channel ribs are outlined with dashed lines. Original magnification=1000×). In FIG. 8C, a Matrigel-loaded microfluidic intercellular communication analysis device 1′ with U937-XP cells injected into the donor cell channel 5′ and with an empty recipient channel was incubated for 48 hours. Subsequently, U937 cells were then injected into the recipient cell channel 8 and, 4 hours after the cell injection, the internalization of U937-XP-secreted EVs by recipient cells was visualized using bright-field and GFP emission filters (arrowheads point at imaged EVs inside the recipient cells. Magnification=1000×). FIG. 8D illustrates accumulation of U937-XP extracellular vesicles within the Matrigel. A Matrigel microfluidic intercellular communication analysis device 1′″ was injected with U937-XP cells in the donor cell channel 5 and the EVs in Matrigel were visualized at 48 hours with a GFP emission filter (original magnification: 1000×). FIG. 8E illustrates timeline for cell injections in EV uptake experiment. Donor U937-XP cells were injected into the donor channel 52 hours prior to imaging to allow for EV accumulation in the donor cell channel 5 and Matrigel matrix channel 2′″. Recipient U937 cells were injected into the recipient cell channel 4 hours prior to imaging to allow time for EV diffusion into the recipient cell channel 8 and uptake into recipient cells.

Donor U937-XPs 30 were injected into the donor cell channel 5 of the Matrigel-infused microfluidic intercellular communication analysis device 1′″ as shown in FIG. 8A. The diffusion of fluorescent vesicles was confirmed by direct comparison of U937-XP donor cells 30 and U937 cells (negative control), by imaging the matrix channel 2′″ at the 1 hour, 24 hour, 48 hour, and 72 hour time points as shown in FIG. 8B. By the 48^{th} hour, the matrix channel 2′″ became visibly fluorescent in the U937-XP donor cells 30. This coincides with the accumulation of fluorescent vesicles in the Matrigel matrix channel 2′″ as shown in FIG. 8D. Then, it was verified that cells in the recipient cell channel 8 can internalize vesicles released by the donor cells. Based on the observed fluorescence accumulation timeline from FIG. 8B, another Matrigel-loaded microfluidic intercellular communication analysis device 1′″ with U937-XP donor cells 30 was prepared, but the recipient cell channel was left empty of any solution for 48 hours in order to permit accumulation of the fluorescent EVs 32 in the donor cell channel 5 and the Matrigel matrix channel 2′″, thus allowing higher EV concentrations for imaging of EV uptake. After 48 hours, recipient U937s were introduced into the recipient cell channel 8, which also allowed entry of accumulated fluorescent EVs 32 into the recipient cell channel 8. The recipient U937s 33 were then imaged after a 4 hour incubation period. The timeline of this procedure is illustrated in FIG. 8E. Successful uptake of fluorescent EVs 32 by the recipient cells 33 was observed in multiple cells as shown in FIG. 8C, confirming that secreted EVs 32 can travel across the matrix channel 2′″ and be subsequently internalized by recipient cells 33 as part of a live EV exchange process. It is important to note that with the availability of an imaging system 50 that allows long-term incubation of cells while performing constant high-frame-rate imaging, real-time EV diffusion and uptake can also be investigated in the microfluidic intercellular communication analysis system 100, where all of the microfluidic channels 2, 5, 8 are filled simultaneously.

Accordingly, FIGS. 5A-8E demonstrate at least the efficacy of the microfluidic intercellular communication analysis device 1,1′″,1^{iv} as a novel and effective assay for monitoring cell-cell exchange of target subjects (e.g., without limitation, EVs, particles, protein, etc.). Distinct cell populations can be injected into separate cell channels to accumulate and exchange EVs and large or small biomolecules, allowing for the observation of cell communication scenarios that more closely mimic the intricacy of a diverse in vivo cell environment. The working concentration of 8 mg/mL Matrigel injected into the chips allowed EVs of at least up to 250 nm to diffuse across. These included exosomes, which were observed to be internalized by recipient cells within the first 12 hour. Therefore, the microfluidic intercellular communication analysis device 1,1′″,1^{iv} simulates in vivo EV exchange, during which cells send and receive exosomes and other EVs constitutively, in contrast to in vitro experimental procedures that involve treatment of an entire cell population with a certain amount of EVs at once. This can be an important consideration in some studies, where EV quantities that are used for in vitro analysis may not translate well to an in vivo setting in which physiological vesicle distribution and clearance influence effective EV availability and dosage (36). Thus, the interconnected chip design with lengthy extended cell channels and live EV secretion can provide a closer portrayal of physiological tissue conditions and enable analysis of the functional consequences of EV and biomolecule communication between physically separated cells. In addition to providing a physiologically relevant platform for EV studies that bridges the in vitro and in vivo approaches, the microfluidic intercellular communication analysis device 1,1′″,1^{iv} also provides some logistical advantages. For instance, the micron size of the cell channels of the chip 1, 1′″, 1^{iv} drastically reduces the required volume of cells down to only 2-10 microliters. Moreover, the use of the chip 1, 1′″, 1^{iv} obviates the need for costly and time-consuming purification of EVs, dramatically reducing the amounts of resources that are needed for various functional studies.

Furthermore, the study using suspended U937 cells and the previous implementation of the chip that used adherent HUVEC cells (25) demonstrate the versatility of the microfluidic intercellular communication analysis device 1,1′″, 1ᵢᵥ with respect to enabling the investigation of diverse cell types. The results with PEGDA hydrogel also provide a strategy for preventing EV diffusion without affecting the passage of soluble factors, thus serving as a negative control for confirming that any observed effects are due to EV exchange. Further highlighting the versatility of the microfluidic intercellular communication analysis device 1,1′″,1^{iv}, the ability to adjust PEGDA pore size should also provide a means of selective size exclusion of the EVs that can migrate across the Matrigel barrier, thus allowing for functional studies of EV subtypes that can be distinguished based on size differences. Matrigel barriers and Transwell filter systems have been utilized previously, both to collect secreted EVs that have selectively diffused through the pores and accumulated in the supernatant (21), and to use pre-isolated EVs for cell migration studies (37). Transwell systems have also been extensively used with or without supplementary Matrigel layers to investigate the role of certain exosome populations in cell migration (38-42). The microfluidic intercellular communication analysis device 1,1′″,1^{iv} circumvents the EV isolation process required for the aforementioned Transwell exosome functional strategies. In addition, it enables natural EV exchange between co-cultured donor and recipient cells, thus better recapitulating the physiological conditions. The Matrigel barrier in the microfluidic intercellular communication analysis device 1′″ also allows the observation of cell migration induced by exchange of bioactive molecules between cell populations in separate channels, as migratory cells can push through the Matrigel barrier. For instance, an accessory channel in a five-channel system can be used for conducting more elaborate experiments that also analyze the migratory behavior of cells towards the middle channel in response to the generation of stimulatory signals. Therefore, such studies can be performed without the need for prior isolation of biomolecules, similar to the utilization of the original chip design (25). Other microfluidic technologies that have been developed in recent years to study cell communication between co-cultured populations rely on more complicated fabrication methods and the use of non-physiological barriers, such as filters or channels with reduced width, and also do not enable cell migration studies (43-45). In future studies, the microfluidic intercellular communication analysis device 1, 1′″, 1^{iv} may be further optimized for large-scale production in order to allow its use by various researchers.

The limited consistency of Matrigel loading, which requires precise manual pressure to be applied during chip preparation, prevents large-scale production of the microfluidic chips from yet being feasible. However, due to the flexibility and ease of chip design modifications, such improvements are achievable as shown with reference to at least FIGS. 2A-2F.

Additionally, the microfluidic intercellular communication analysis device 1, 1″, 1^{iv} may be manipulated into a device for facile EV collection and purification. The functional assay capabilities of the microfluidic intercellular communication analysis device 1, 1′″, 1^{iv} may be further demonstrated by integrating it into ongoing EV research. For instance, it has been shown that purified exosomes from cells infected with the Rift Valley fever virus (RVFV) can induce significant production of RIG-I-dependent interferon-beta (IFN-β) from naïve recipient cells, making them strongly refractory to infection with RVFV (4). This can be analyzed directly on the microfluidic intercellular communication analysis device 1, 1′″, 1^{iv} by injecting RVFV-infected cells into the donor cell channel and naïve cells into the recipient cell channel. Furthermore, it can be tested whether exosomes that are, in turn, released by the recipient cells can also modulate the immune responses of naïve cells injected into the accessory channel. Such studies will further confirm the utility of the microfluidic intercellular communication analysis device 1, 1′″, 1^{iv} and expand even further on the types and complexity of functional assays that can be performed.

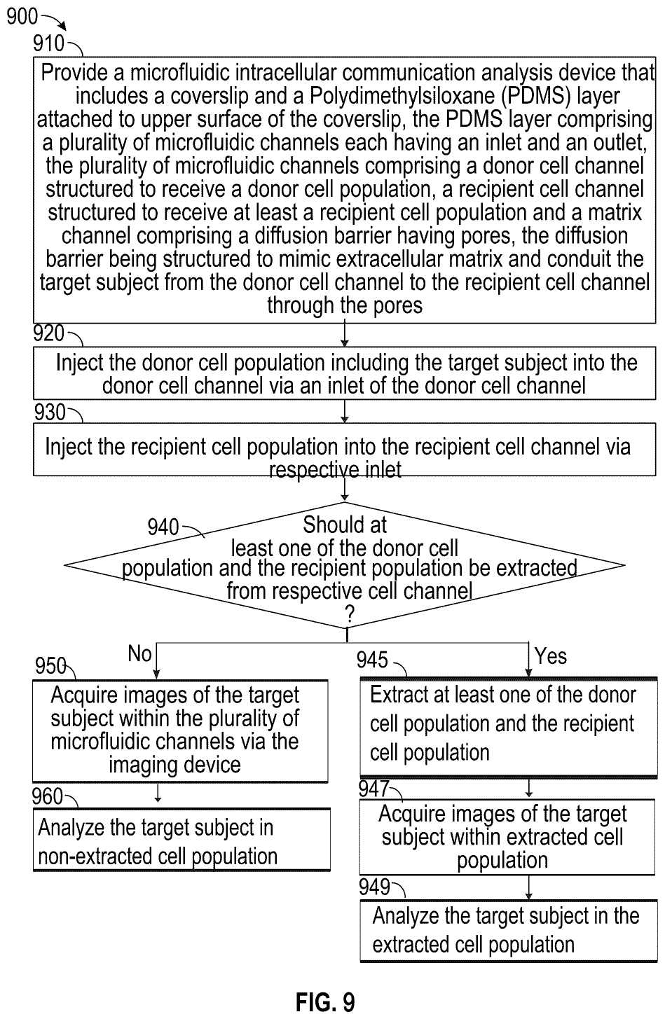

Referring back to Figures, FIG. 9 is a flow chart for a method 900 of analyzing intercellular communication of a target subject according to a non-limiting, example embodiment. The method 900 may be performed by the microfluidic intercellular communication analysis system 100 of FIG. 1 or the components thereof. The method 900 is described also with reference to FIGS. 10A-D as a particular step is illustrated by these figures.

At 910, a microfluidic intercellular communication analysis system is provided. The microfluidic intercellular communication analysis system includes a microfluidic intercellular communication analysis device includes a coverslip and a Polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, including a type of diffusion barrier that can mimic extracellular matrix, that conduits the target subject from the donor cell channel to the recipient cell channel through the pores, the donor cell channel and the recipient cell channel each comprising inlets and outlets having an arc angle ranging from 180° to 300°, the arc angle being structured to prevent cell aggregation in the inlets, the outlets and/or channel surfaces of the donor cell channel and the recipient cell channel.

At 920, a donor cell population is injected into the donor cell channel via respective inlet.

At 930, a recipient cell population is injected into the recipient cell channel via respective inlet. The injections of the donor cell population and the recipient cell population may occur sequentially or simultaneously. Cell injections may be made using a syringe pump coupled to syringe tubes disposed within inlets and outlets of cell channels as shown in FIG. 10A. Alternatively, the cell injections may be made by placing a tip of pipette 80 (FIG. 10D) within cell channel inlets for a predefined time and volume such that the cell population is transferred from the pipette 80 to cell channels based on gravity as shown in FIG. 10B. The predefined time may be, e.g., without limitation, from 30 min to 60 min. The predefined volume may be, e.g., without limitation, from 20 μL to 60 μL.

At 940, it is determined if at least one of the donor cell population and the recipient cell population is to be extracted from respective cell channel. If yes, the method 900 proceeds to 945. If no, the method 900 proceeds to 950. At 945, the at least one of the donor cell population and the recipient population is extracted from respective outlet, at 947 the imaging device acquires images of the target subject from extracted cell population and at 949, the target subject in the extracted cell population are analyzed based on the images acquired and/or for performance of assays including functional characterizations of the extracted cell population. That is, the extraction of the cell population is not only for imaging purposes, but it could also be for performance of various assays, including functional characterizations, on the extracted cells. For extracting the at least one of the donor cell population and the recipient population, as shown in FIG. 10C, an empty tip of the pipette 80 may be placed within respective outlet and upon such placement, cell media may be pumped into respective inlet via a syringe pump, thereby pushing the at least one of the donor cell population and the recipient population into the tip of the pipette 80. Once a sufficient amount of the at least one of the donor cell population and the recipient population flows into the tip of the pipette 80, the at least one of the donor cell population and the recipient population may be extracted from the tip of the pipette for analysis.

At 950, the imaging device automatically and continuously acquires images of the target subject within the plurality of microfluidic channels over a period.

At 960, the target subject in non-extracted cell population is analyzed based on the images acquired and/or at least for attachment properties of suspension cells or cell cycle properties. The analysis includes intercellular communication or lack thereof of the target subject. For example, the migratory behavior of the target subject or lack thereof may be studied. A confirmed migratory behavior of a target subject can be utilized in delivering pharmaceutical products within the target subject for, e.g., without, limitation, disease treatment, therapeutic purposes, etc. For example, the EVs infected with the Rift Valley fever virus (RVFV) extracted from the recipient cell channel can be collected and purified. Such purified EVs have been shown to induce a significant production of RIG-I-dependent interferon-beta (IFN-β) from naïve recipient cells, making the latter strongly refractory to infection with the RVFV. Such refractory effect can be directly analyzed using the microfluidic intercellular communication analysis device by injecting the RVFV-infected cells into the donor cell channel and naïve cells into the recipient cell channel. Further, it can be further tested to determine if exosomes released by the recipient cells can also modulate the immune responses of naïve cells injected into a recipient cell channel. Such further tests and analysis can be used to explore the use of the purified EVs as a vaccine against the RVFV. Therefore, the utility and efficacy of the microfluidic intercellular communication device are expansive, allowing investigation and research of the areas and subjects that were not previously possible using the conventional isolation or cell-cell communication analysis devices.

Materials and Methods:

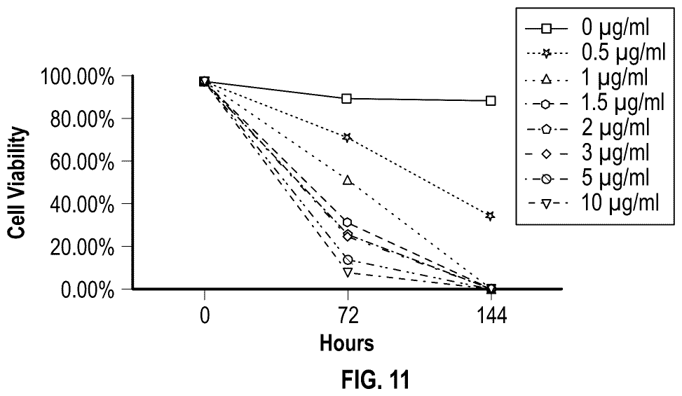

Some of materials and methods below are illustrated with reference to corresponding Figures (FIGS. 11-13).

Microfluidic Intercellular Communication Analysis Device Design: A CAD drawing with multiple chip replicates was made using AutoCAD. The CAD drawing was submitted to MuWells (San Diego, CA, USA) to produce a chrome mask from the CAD drawing and fabricate a positive mold on a silicon wafer. The Microfluidic Intercellular Communication Analysis Device and/or a part thereof may be also referred to as a “chip” herein.

Microfluidic Intercellular Communication Analysis Device Production/Optimization: Polydimethylsiloxane (PDMS; Sylgard 184) was mixed at a base-to-curing-agent ratio of 10:1. The silicon wafer was rinsed with isopropyl alcohol and dried with compressed air. The PDMS mixture was then poured onto the positive mold on the silicon wafer and degassed under vacuum for 30 min. Once all bubbles are removed, the PDMS was baked at 70° C. for 1 hour. A large slab of PDMS was cut from the wafer region containing the templates. The PDMS slab was carefully removed and subsequently cut into individual chips. Holes were punctured into the inlets/outlets using 21- and 16-gauge blunt-end needles for the central/side (e.g., cell channels 5, 8) and matrix channels 2, respectively. The PDMS chips and coverslips were then rinsed with ethanol and blown dry with compressed air to remove the PDMS debris. A handheld laboratory corona treater (BD-20AC, Electro-Technic Products, Chicago, IL, USA) was then used to plasma-activate the glass and PDMS surfaces for bonding, with settings at the maximum output voltage (˜45 kV) for less than 5 s. The activated PDMS chips were placed on the activated coverslips, and air bubbles were removed. The chips were then baked at 70° C. for 1 hour and transferred to a hot plate for incubation at 200° C. for 1 hour in order to hydrophobize the PDMS. Subsequently, the corona treater was used to apply a plasma jet through the matrix channel 2 in order to selectively activate it. To facilitate the selectivity of this activation, an electrode (e.g., without limitation, a copper ground wire 26) was inserted at the other end 9 of the matrix channel 2 and the other inlets 6, 9 and outlets 7, 10 were blocked with a slab of PDMS in order to use the pressure created by the plasma shock to funnel it through the matrix channel 2 and prevent leakage into the middle and side channels 5, 8. After activation, the chips 1 were sterilized by exposure to UV light (365 nm) for 10 min. A volume of 3 μL of growth-factor-reduced Matrigel (Dow Corning, Midland, MI, USA) was then injected into the matrix channel 2′″ and allowed to polymerize for 20 min at room temperature. After polymerization, the channels 5, 8 were coated with 0.05 mg/mL poly-D-lysine (Gibco, Waltham, MA, USA, REFA38904-01) for 1 hour and subsequently rinsed and filled with PBS until ready for cell injection. For use of poly(ethylene glycol) diacrylate (PEGDA) hydrogels, all preparation steps remained the same, except that the PEGDA solution was injected in place of Matrigel. PEG-400-DA was diluted in DI water to form a 20% w/v PEGDA solution. The photoinitiator, Irgacure (Sigma-Aldrich, St. Louis, MO, USA), was added to this solution at 0.5% w/v and vortexed for 30 s. This PEGDA/Irgacure solution was directly injected into the matrix channel 2^{iv}. The injected matrix channel 2^{iv} was polymerized under UV light for 15 min, and the chip 1^{iv} was subsequently coated or filled with PBS.

Liposome Preparation: DMPC powder (850345P) and DOPE-PEG(2000)-N-Cy5 chloroform solution (880153C) were purchased from Avanti Polar Lipids (Alabaster, AL, USA); 70 nm and 250 nm liposome stock solutions (1 mg/mL) were produced by first dissolving DMPC in chloroform (Fisher Chemical, Waltham, MA, USA, C298-500) and then adding DOPE-PEG(2000)-N-Cy5 (99.9:0.1-DMPC:DOPE-PEG(2000)-N-Cy5) for future fluorescent visualization. The lipids were desiccated overnight in a vacuum chamber to form a lipid film. The next day, the lipids were dissolved in PBS (Gibco, 70011-044) and strongly vortexed. The lipid solution was then extruded through an Avanti Mini-Extruder (610000-1EA); 70 nm liposomes were passed through a 0.2 μm Nuclepore track-etched polycarbonate membrane filter (Whatman, Maidstone, UK, 800281), followed by a 0.05 nm filter (800308); 250 nm liposomes were passed through a 0.4 m filter (800282) and then a 0.2 μm filter; 10 mm filter supports were used (Avanti Polar Lipids, 610014-1Ea). The size of the liposomes (Table 1) was confirmed by dynamic light scattering (DLS) using a Zetasizer NanoSampler (Malvern, UK), and they were stored at 4° C. until further use.

Cell Line and Maintenance: U937 cells were purchased from the ATCC and maintained in RPMI 1640 medium supplemented with L-glutamine, 25 mM HEPES (Corning, 10-041-CV), and 10% exosome free heat-inactivated fetal bovine serum (FBS) (Corning, Corning, NY, USA, 35-010-CV) that was prepared by ultracentrifugation at 100,000×g to remove FBS exosomes. This culture medium is designated as RPMI++ in the manuscript. Cells were incubated at 37° C. with 5% CO₂ and split every 3-4 days. Cell count and viability measurements were conducted using a Luna Automated Cell Counter (Logos Biosystems, Annandale, VA, USA, L10001) in fluorescence measurement mode and using AO/PI dyes (VitaScientific, College Park, MD, USA, F23001). Cells within chips 1 were also maintained in RPMI++, and the chips 1 were kept inside a humidity container to alleviate long-term dehydration.

Puromycin Kill Curve: FIG. 9 illustrates puromycin kill curves according to a non-limiting, example embodiment of the disclosed concept. To determine the optimal concentration of puromycin to be used for antibiotic selection, multiple concentrations of puromycin were tested. For each concentration, cell viability was measured at 0 hours, 72 hours, and 144 hours. A total of 3.5×10⁴ U937 cells in 200 μL of RPMI++ were added to 8 wells of a 48-well plate, and the following range of final puromycin concentrations was added to the wells: 0, 0.5, 1, 1.5, 2, 3, 5, and 10 μg/mL. The cells were counted again at 72 hour before replenishing the media and puromycin. Following another 72 hour of incubation, the cells were counted again. Based on the results, 1.5 μg/mL was selected as the optimal puromycin concentration.

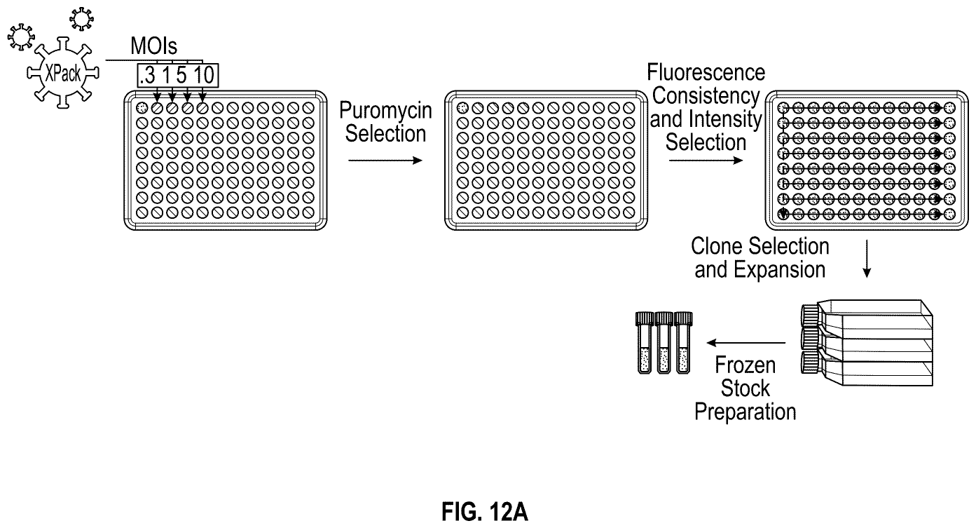

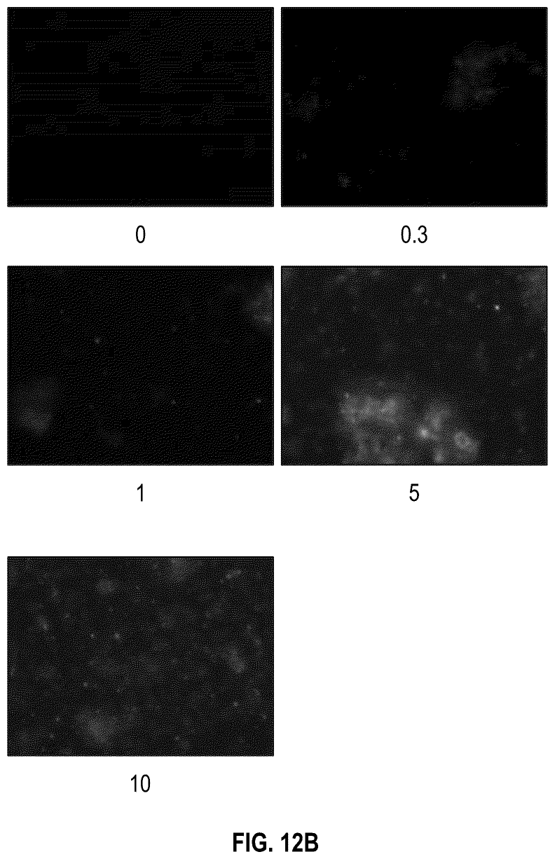

U937-XP Cell Line Generation: FIGS. 12A-B illustrate U937-XP cell line generation according to a non-limiting, example embodiment of the disclosed concept. In FIG. 10A, 2.5×10⁵ U937 cells were spun down at 935×g for 5 min at room temperature. The cell pellets were washed with PBS and then resuspended in 200 μL of RPMI++ supplemented with 4 μg/mL polybrene (Specialty Media, Thermo Fisher Scientific, TR-1003-G) and transferred to a 48-well plate. XPack lentivirus (XPAK730VA-1), purchased from System Biosciences (Palo Alto, CA, USA), was added to the cells at MOIs of 0.3, 1, 5, and 10. A mock infection control well is also included. The cells were then spinoculated by centrifugation at 1340×g for 2 hour at 32° C. The supernatant was removed, and the cells were washed in serum-free RPMI with polybrene and centrifuged at 1455×g for 5 min. The supernatant was removed and the cell pellets were resuspended in fresh RPMI++ and transferred to a fresh well of a 48-well plate to incubate for 24 hour at 37° C. and 5% CO₂. After 24 hour, the medium was replenished. At 72 hour post-transduction, following confirmation of GFP fluorescence in the cells by imaging using an EVOS FL microscope (Invitrogen, Waltham, MA, USA), the culture medium was replaced with medium containing 1.5 μg/mL of puromycin. Every 72 hour, the control cell population count was checked for total cell elimination, and the puromycin-containing RPMI++ was replenished. After 9 days, the control cells had completely died, and the remaining cell populations were checked for optimal GFP fluorescence using an EVOS FL microscope. As shown in FIG. 10B, the cells infected at an MOI of 10 had the most consistent and the brightest levels of GFP expression. Thus, 1.0×10⁴ cells from this cell population were transferred to a 96-well plate and serially diluted 2-fold vertically and then horizontally down the entire columns and rows. Several wells were chosen for having the smallest numbers of clones and then grown for 4 days before being transferred to a 6-well plate and allowed to grow for another 48 hour. They were selected again based on qualitative GFP expression. The selected clones were then transferred to a new plate and grown to a higher density to be used in the preparation of frozen stocks for later experiments.

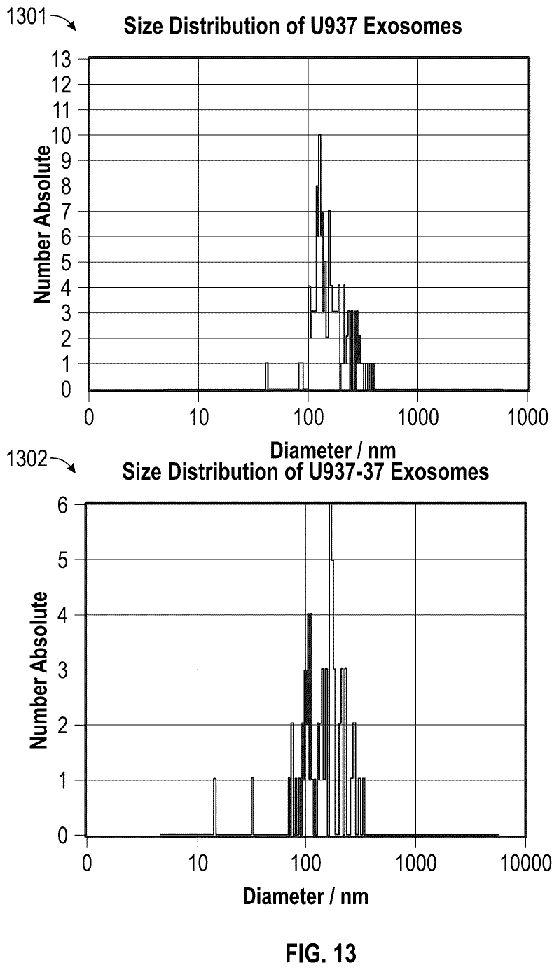

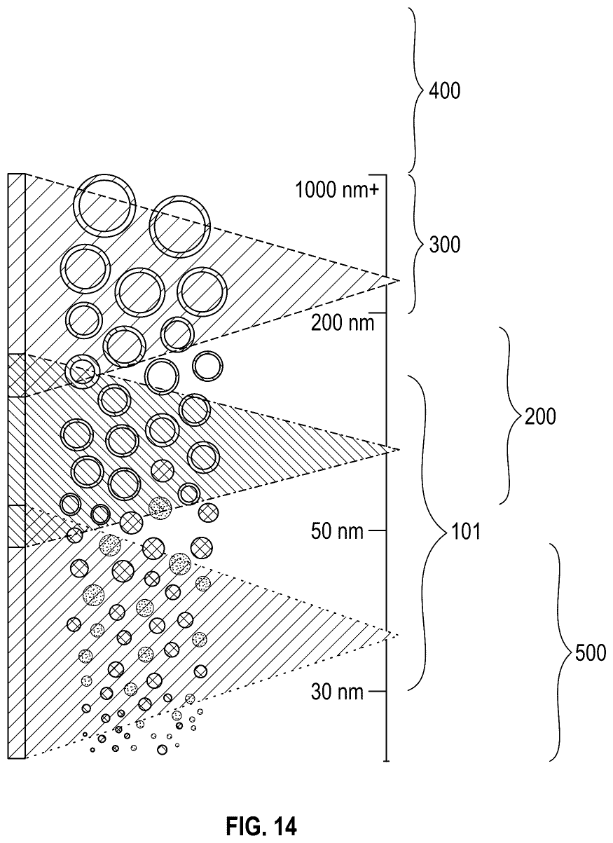

Extracellular Vesicle (EV) Purification: FIG. 13 illustrates size characterization of U937 and U937-XP exosomes according to a non-limiting, example embodiment of the disclosed concept. The graph 1302 shows Zetaview nanoparticle tracking analysis (NTA) of exosomes purified from stable U937-XP cells; Original vesicle concentration: 4.98×108 particles/ml; Median diameter: 146.4 nm; Standard Deviation (S.D.): 64.6 nm. The graph 1301 shows U937 exosomes being analyzed by NTA. The U937 exosomes were found to be similar in size and concentration; Original vesicle concentration: 5.2×10⁸ particles/ml; Median diameter: 144.2 nm, S.D.: 59.3 nm. In addition to filter sterilization of the final purified sample, all solutions and tubes used during this purification procedure were also sterilized as an extra precaution. U937 cells were seeded at 5×10⁵ cells/mL in 100 mL of exosome-free medium (EFM). At 72 hour, the cells were spun down at 600×g for 5 min. The supernatant was collected and spun down at 2000×g for 20 min, and the resulting supernatant was centrifuged again at 10,000×g for 30 min. The 2000×g and 10,000×g pellets (2K and 10K pellets) were resuspended in 100 μL of PBS for further analysis, and the remaining supernatant from the 10K spin was filter-sterilized through a 0.2 μm bottle-top filter (VWR, 10040-468) and subsequently spun down at 167,000×g for 2 hour to pellet the exosomes. The supernatant was removed, and the exosome pellet was resuspended in PBS and centrifuged again at 167,000×g for 2 hour. The exosomes were then resuspended in 400 μL of PBS and either left unlabeled or fluorescently labeled by incubating them with 25 μL of DOPE-PEG(2000)-N-Cy5 at 37° C. Both unlabeled and Cy5-labeled exosomes were then purified further side by side, by overlaying them on top of a stepwise sucrose (VWR, 0335-1KG) density gradient containing density fractions of 1.25, 1.167, 1.149, 1.103, 1.064, and 1.031 g/mL followed by ultracentrifugation at 167,000×g. Through numerous (>30) biological repeats and characterizations of this purification procedure, it had been previously verified that the exosomes recovered from U937 cells migrate to the 1.149 and 1.103 g/mL density fractions. Therefore, these two fractions were combined, diluted by the addition of 2 mL of PBS, and centrifuged at 167,000×g to remove the sucrose. The pellet was then resuspended in 100 μL of PBS and filter-sterilized using a 0.20 μm sterile syringe filter (VWR, 28145-477). Following addition of the Halt Protease Inhibitor Cocktail (Thermo Scientific, Waltham, MA, USA, 1862209) at 1× final concentration, the exosomes were stored at −80° C. until further use. The size and quantity of U937-XP exosomes were determined (as shown in FIG. 11) using ZetaView nanoparticle tracking analysis (Particle Metrix GmbH, Inning am Ammersee, Germany), as previously described (4).

EV Fluorescence Measurement and Analysis of the EV Pellets: Fluorescence readings were taken for the 2K pellets, 10K pellets, and purified exosomes from both U937 and U937-XP cell lines using a Tecan Safire 2 multi-detection microplate reader and analyzed using Magellan software (Tecan, Minnedorf, Switzerland). A volume of 30 μL of each vesicle population was used for analysis; the protein concentrations of the 2K pellets, the 10K pellets, and the purified exosomes were on average 400 μg/mL, 30 μg/mL, and around 250 μg/mL, respectively. The experiment was performed in 3 biological replicates. Unpaired Student's t-tests were performed for statistical analysis and comparison between U937 and U937-XP vesicles.

Vesicle and Cell Injections into Chips: A 5 μl volume of either purified exosomes, liposomes (1 mg/mL), or 500 nm Fluoresbrite YG carboxylate microspheres (Polysciences, Warrington, PA, USA, 17152-10) (25 μg/mL) was injected into the chips by pipetting into the inlet ports of the donor channels. A 5 μL volume from a suspension of 2×10⁷ cells/mL was injected into the recipient cell channels at a flow rate of 0.5 L/min using a Fusion 200 (Chemyx, Stafford, TX, USA) syringe pump, a 250 μL syringe (Hamilton, Reno, NV, USA 81175), and 24-gauge PTFE tubing (Component Supply, Sparta, TN, USA, TWTT-24-C) tightly inserted into the injection port. For cell injection into donor channels, a 10 μL volume of cell suspension at 2×10⁷ cells/mL was injected at a flow rate of 1 μL/min. Excess solution was wiped away from the outlet port.

Fluorescent Imaging: The cells imaged on slides were first fixed by incubation in 2% PFA (Macron Fine Chemicals, Avantor, Center Valley, PA, USA, H121-08) in PBS for 20 min at room temperature, followed by two PBS washes. The cells were then mounted onto glass slides using DAPI-Fluoromount G (SouthernBiotech, Birmingham, AL, USA, 0100-20). Fluorescent imaging of the fixed cells and chips was performed using a Ti2 series inverted microscope (Nikon, Tokyo, Japan) outfitted with a 100× oil immersion objective, using standard bright-field and Cy5 (λEX: 625, λEM: 670 nm), DAPI (λEX: 360 nm, λEM: 460 nm), or GFP (λEX: 480 nm, λEM: 535 nm) filters. Z-stack imaging, merged channels, 3D deconvolution, and stitching were performed using Nikon's NIS-Elements AR software.

To sum, the microfluidic intercellular communication analysis device 1, 1′, 1″, 1′″, 1^{iv} provides a novel and versatile microfluidic platform to enable future mechanistic investigations of real-time intercellular communication-including EV exchange studies-across various disciplines. In addition to Matrigel, the microfluidic intercellular communication analysis system 100 can also accommodate other diffusion barrier substances to allow for tailor-made studies, including hydrogels of variable pore size and composition. The microfluidic intercellular communication analysis system 100 can also be scaled to accommodate various study needs, as it has been demonstrated by adapting the microfluidic intercellular communication analysis device 1 from a three-cell lane design (25) to an optimized two-cell lane design. The ability to selectively inject the diffusion barrier (e.g., Matrigel or PEGDA hydrogel) within a single channel is a key feature to enable the facile preparation of the microfluidic intercellular communication devices 1, 1′, 1″, 1′″, 1^{iv} which should facilitate their adoption and use. Further development and study-specific optimization of the diffusion barrier and matrix rib length will also enable control over the timescale of vesicle diffusion and vesicle communication study. In addition, the use of PEGDA or other hydrogel barriers with various pore sizes should provide a means of selecting EV subtypes that migrate across, or allow their retention, enabling functional studies of EV subtypes that can be distinguished based on size differences.

### BIBLIOGRAPHY

1. E L Andaloussi, S.; Mäger, I.; Breakefield, X. O.; Wood, M. J. A. Extracellular Vesicles: Biology and Emerging Therapeutic Opportunities. Nat. Rev. Drug Discov. 12, 347-357 (2013).
2. Chuo, S. T.-Y.; Chien, J. C.-Y.; Lai, C. P.-K. Imaging Extracellular Vesicles: Current and Emerging Methods. J. Biomed. Sci. 2018, 25, 91 (2018).
3. Olanrewaju, A. A.; Hakami, R. M. The Messenger Apps of the Cell: Extracellular Vesicles as Regulatory Messengers of Microglial Function in the CNS. J. Neuroimmune Pharmacol. 15, 473-486 (2020).
4. Alem, F.; Olanrewaju, A. A.; Omole, S.; Hobbs, H. E.; Ahsan, N.; Matulis, G.; Brantner, C. A.; Zhou, W.; Petricoin, E. F.; Liotta, L. A.; et al. Exosomes Originating from Infection with the Cytoplasmic Single-Stranded RNA Virus Rift Valley Fever Virus (RVFV) Protect Recipient Cells by Inducing RIG-I Mediated IFN-β Response That Leads to Activation of Autophagy. Cell Biosci. 11, 220. (2021).
5. Pegtel, D. M.; Gould, S. J. Exosomes. Annu. Rev. Biochem. 88, 487-514 (2019)
6. Doyle, L. M.; Wang, M. Z. Overview of Extracellular Vesicles, Their Origin, Composition, Purpose, and Methods for Exosome Isolation and Analysis. Cells. 8, 727 (2019)
7. Pegtel, D. M.; Cosmopoulos, K.; Thorley-Lawson, D. A.; van Eijndhoven, M. A. J.; Hopmans, E. S.; Lindenberg, J. L.; de Gruijl, T. D.; Wurdinger, T.; Middeldorp, J. M. Functional Delivery of Viral MiRNAs via Exosomes. Proc. Natl. Acad. Sci. USA 107, 6328-6333 (2010)
8. Prada, I.; Meldolesi, J. Binding and Fusion of Extracellular Vesicles to the Plasma Membrane of Their Cell Targets. Int. J. Mol. Sci. 17, 1296 (2016).
9. Zhang, L.; Yu, D. Exosomes in Cancer Development, Metastasis, and Immunity. Biochim. Biophys. Acta Rev. Cancer 1871, 455-468 (2019).
10. Malm, T.; Loppi, S.; Kanninen, K. M. Exosomes in Alzheimer's Disease. Neurochem. Int. 97, 193-199 (2016)
11. Wu, X.; Zheng, T.; Zhang, B. Exosomes in Parkinson's Disease. Neurosci. Bull. 33, 331-338 (2017)
12. Wu, R.; Gao, W.; Yao, K.; Ge, J. Roles of Exosomes Derived from Immune Cells in Cardiovascular Diseases. Front. Immunol. 10, 648 (2019).
13. Fleming, A.; Sampey, G.; Chung, M.-C.; Bailey, C.; van Hoek, M. L.; Kashanchi, F.; Hakami, R. M. The Carrying Pigeons of the Cell: Exosomes and Their Role in Infectious Diseases Caused by Human Pathogens. Pathog. Dis. 71, 109-120 (2014).
14. Schorey, J. S.; Cheng, Y.; Singh, P. P.; Smith, V. L. Exosomes and Other Extracellular Vesicles in Host-Pathogen Interactions. EMBO Rep. 16, 24-43 (2015).
15. Schwab, A.; Meyering, S. S.; Lepene, B.; Iordanskiy, S.; van Hoek, M. L.; Hakami, R. M.; Kashanchi, F. Extracellular Vesicles from Infected Cells: Potential for Direct Pathogenesis. Front. Microbiol. 6, 1132 (2015).
16. Lin, J.; Li, J.; Huang, B.; Liu, J.; Chen, X.; Chen, X.-M.; Xu, Y.-M.; Huang, L.-F.; Wang, X.-Z. Exosomes: Novel Biomarkers for Clinical Diagnosis. Sci. World J. 2015, 657086 (2015).
17. Yang, D.; Zhang, W.; Zhang, H.; Zhang, F.; Chen, L.; Ma, L.; Larcher, L. M.; Chen, S.; Liu, N.; Zhao, Q.; et al. Progress, Opportunity, and Perspective on Exosome Isolation-Efforts for Efficient Exosome-Based Theranostics. Theranostics 10, 3684-3707 (2020).
18. Gurunathan, S.; Kang, M.-H.; Jeyaraj, M.; Qasim, M.; Kim, J.-H. Review of the Isolation, Characterization, Biological Function, and Multifarious Therapeutic Approaches of Exosomes. Cells 8, 307 (2019).
19. Betzer, O.; Barnoy, E.; Sadan, T.; Elbaz, I.; Braverman, C.; Liu, Z.; Popovtzer, R. Advances in Imaging Strategies for in Vivo Tracking of Exosomes. WIREs Nanomed. Nanobiotechnol. 12, e1594 (2020).
20. Salunkhe, S.; Dheeraj; Basak, M.; Chitkara, D.; Mittal, A. Surface Functionalization of Exosomes for Target-Specific Delivery and in Vivo Imaging & Tracking: Strategies and Significance. J. Control. Release 326, 599-614 (2020).
21. Luoto, J. C.; Coelho-Rato, L. S.; Bengs, S. H.; Roininen, J.; Eriksson, J. E.; Sistonen, L.; Henriksson, E. In Vivo-Mimicking 3D Cultures Secrete Distinct Extracellular Vesicles upon Cancer Cell Invasion. bioRxiv (2020).
22. Zhu, Q.; Heon, M.; Zhao, Z.; He, M. Microfluidic Engineering of Exosomes: Editing Cellular Messages for Precision Therapeutics. Lab Chip, 18, 1690-1703 (2018).
23. Jo, W.; Jeong, D.; Kim, J.; Cho, S.; Jang, S. C.; Han, C.; Kang, J. Y.; Gho, Y. S.; Park, J. Microfluidic Fabrication of Cell-Derived Nanovesicles as Endogenous RNA Carriers. Lab Chip 14, 1261-1269 (2014).
24. Shin, Y.; Han, S.; Jeon, J. S.; Yamamoto, K.; Zervantonakis, I. K.; Sudo, R.; Kamm, R. D.; Chung, S. Microfluidic Assay for Simultaneous Culture of Multiple Cell Types on Surfaces or within Hydrogels. Nat. Protoc. 7, 1247-1259 (2012).
25. Roberts, S. A.; Waziri, A. E.; Agrawal, N. Development of a Single-Cell Migration and Extravasation Platform through Selective Surface Modification. Anal. Chem. 88, 2770-2776 (2016).
26. Li, R.; Hebert, J. D.; Lee, T. A.; Xing, H.; Boussommier-Calleja, A.; Hynes, R. O.; Lauffenburger, D. A.; Kamm, R. D. Macrophage-Secreted TNF and TGF1 Influence Migration Speed and Persistence of Cancer Cells in 3D Tissue Culture via Independent Pathways. Cancer Res 77, 279-290 (2017).
27. Kojima, R.; Bojar, D.; Rizzi, G.; Hamri, G. C.-E.; El-Baba, M. D.; Saxena, P.; Auslinder, S.; Tan, K. R.; Fussenegger, M. Designer Exosomes Produced by Implanted Cells Intracerebrally Deliver Therapeutic Cargo for Parkinson's Disease Treatment. Nat. Commun. 9, 1305 (2018).
28. Tomasetti, L.; Liebl, R.; Wastl, D. S.; Breunig, M. Influence of PEGylation on Nanoparticle Mobility in Different Models of the Extracellular Matrix. Eur. J. Pharm. Biopharm. 108, 145-155 (2016).
29. Ishraq Bari, S. M.; Hossain, F. B.; Nestorova, G. G. Advances in Biosensors Technology for Detection and Characterization of Extracellular Vesicles. Sensors 2021, 21, 7645 (2021).
30. Sidhom, K.; Obi, P. O.; Saleem, A. A Review of Exosomal Isolation Methods: Is Size Exclusion Chromatography the Best Option? Int. J. Mol. Sci. 21, 6466 (2020).
31. Louten, J. Virus Structure and Classification. Essent. Hum. Virol. 19-29 (2016).
32. Gavira, J. A.; Cera-Manjarres, A.; Ortiz, K.; Mendez, J.; Jimenez-Torres, J. A.; Patiño-Lopez, L. D.; Torres-Lugo, M. Use of Cross-Linked Poly(Ethylene Glycol)-Based Hydrogels for Protein Crystallization. Cryst. Growth Des. 14, 3239-3248 (2014).
33. Yim, N.; Choi, C. Extracellular Vesicles as Novel Carriers for Therapeutic Molecules. BMB Rep. 49, 585 (2012).
34. Shen, B.; Wu, N.; Yang, J.-M.; Gould, S. J. Protein Targeting to Exosomes/Microvesicles by Plasma Membrane Anchors. J. Biol. Chem. 286, 14383 (2011).
35. Panagopoulou, M. S.; Wark, A. W.; Birch, D. J. S.; Gregory, C. D. Phenotypic Analysis of Extracellular Vesicles: A Review on the Applications of Fluorescence. J. Extracell. Vesicles 9, 1710020 (2020).
36. Kennedy, T. L.; Russell, A. J.; Riley, P. Experimental Limitations of Extracellular Vesicle-Based Therapies for the Treatment of Myocardial Infarction. Trends Cardiovasc. Med. 31, 405-415 (2021).
37. Li, P.; Lu, X.; Hu, J.; Dai, M.; Yan, J.; Tan, H.; Yu, P.; Chen, X.; Zhang, C. Human Amniotic Fluid Derived-Exosomes Alleviate Hypoxic Encephalopathy by Enhancing Angiogenesis in Neonatal Mice after Hypoxia. Neurosci. Lett. 768, 136361 (2022).
38. Wang, Y.; Li, P.; Mao, S.; Mo, Z.; Cao, Z.; Luo, J.; Zhou, M.; Liu, X.; Zhang, S.; Yu, L. Exosome CTLA-4 Regulates PTEN/CD44 Signal Pathway in Spleen Deficiency Internal Environment to Promote Invasion and Metastasis of Hepatocellular Carcinoma. Front. Pharmacol. 12, 757194 (2021).
39. Zhang, Y.; Tan, X.; Lu, Y. Exosomal Transfer of Circ_0006174 Contributes to the Chemoresistance of Doxorubicin in Colorectal Cancer by Depending on the MiR-1205/CCND2 Axis. J. Physiol. Biochem. 78, 39-50 (2022).
40. Hu, N.; Zeng, X.; Tang, F.; Xiong, S. Exosomal Long Non-Coding RNA LIPCAR Derived from OxLDL-Treated THP-1 Cells Regulates the Proliferation of Human Umbilical Vein Endothelial Cells and Human Vascular Smooth Muscle Cells. Biochem. Biophys. Res. Commun. 575, 65-72 (2020).
41. Wang, L.; Chen, J.; Lu, C. Circular RNA Foxo3 Enhances Progression of Ovarian Carcinoma Cells. Aging 2021, 13, 22432-22443 (2021).
42. Dong, H.; Wang, M.; Li, Q. Exosomal MiR-4488 and MiR-1273g-5p Inhibit the Epithelial-Mesenchymal Transition of Transforming Growth Factor B2-Mediated Retinal Pigment Epithelial Cells by Targeting ATP-Binding Cassette A4. Bioengineered 12, 9693-9706 (2021).
43. Fang, G.; Lu, H.; Aboulkheyr Es, H.; Wang, D.; Liu, Y.; Warkiani, M. E.; Lin, G.; Jin, D. Unidirectional Intercellular Communication on a Microfluidic Chip. Biosens. Bioelectron. 175, 112833 (2021).
44. Boos, J. A.; Misun, P. M.; Brunoldi, G.; Furer, L. A.; Aengenheister, L.; Modena, M.; Rousset, N.; Buerki-Thurnherr, T.; Hierlemann, A. Microfluidic Co-Culture Platform to Recapitulate the Maternal-Placental-Embryonic Axis. Adv. Biol. 5, 2100609 (2021).
45. Shimasaki, T.; Yamamoto, S.; Omura, R.; Ito, K.; Nishide, Y.; Yamada, H.; Ohtomo, K.; Ishisaka, T.; Okano, K.; Ogawa, T.; et al. Novel Platform for Regulation of Extracellular Vesicles and Metabolites Secretion from Cells Using a Multi-Linkable Horizontal Co-Culture Plate. Micromachines 12, 1431 (2021).

All publications and patents referred to herein are incorporated by reference. Various modifications and variations of the described subject matter will be apparent to those skilled in the art without departing from the scope and spirit of the invention. Although the invention has been described in connection with specific embodiments, it should be understood that the invention as claimed should not be unduly limited to these embodiments. Indeed, various modifications for carrying out the invention are obvious to those skilled in the art and are intended to be within the scope of the following claims.

What is claimed is:

1. A microfluidic intercellular communication analysis device, comprising:
a coverslip; and
a Polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the diffusion barrier being structured to mimic extracellular matrix and conduit a target subject from the donor cell channel to the recipient cell channel through the pores, the donor cell channel and the recipient cell channel each comprising inlets and outlets having an arc angle ranging from 180° to 300°, the arc angle being structured to prevent cell aggregation in the inlets, the outlets and/or channel surfaces of the donor cell channel and the recipient cell channel, wherein upon injection of the donor cell population and the recipient cell population respective cell channels, the target subject is imaged by an imaging device couplable to the microfluidic intercellular communication analysis device and analyzed for intercellular communication thereof, and/or functional characterizations for ensuing intercellular communication effects.

2. The microfluidic intercellular communication analysis device of claim 1, wherein the PDMS layer has a thickness of 3-4 mm such that the magnification of the imaging device required for the target subject is achieved without bending or damaging the coverslip.

3. The microfluidic intercellular communication analysis device of claim 1, wherein the matrix channel is selectively activated by a plasma pulse directed only at the matrix channel using an electrode placed in an outlet of the matrix channel and a tip of a plasma generator placed in an inlet of the matrix channel with inlets and outlets of the donor cell channel and the recipient cell channel being blocked.

4. The microfluidic intercellular communication analysis device of claim 1, wherein the diffusion barrier comprises a porous hydrogel having a pore size appropriate for passing the target subject from the donor cell channel into the recipient cell channel via the matrix channel, the hydrogel comprising a plurality of hydrogels each having different pore sizes so as to allow for size selection of particles that diffuse across each hydrogel and for determining a population of particles that exert observed functional effects, the plurality of hydrogels comprising at least Matrigel and PEGDA gel.

5. The microfluidic intercellular communication analysis device of claim 1, wherein inlets and outlets of the donor cell channel and the recipient cell channel are structured to have a gauge such that a seal forms between surfaces of the inlets and surface of an injection device during cell population injection.

6. The microfluidic intercellular communication analysis device of claim 1, wherein the donor cell channel and the recipient cell channel are structured to have a height that prevents cell aggregation in the inlets, the outlets and/or the channel surfaces thereof, the height ranging from 200 μm to 400 μm.

7. The microfluidic intercellular communication analysis device of claim 1, wherein the PDMS layer is hydrophobized at a temperature ranging from 180° C. to 250° C. for a period ranging from 60 minutes to 70 minutes.

8. The microfluidic intercellular communication analysis device of claim 1, wherein inlet and outlet of the matrix channel each comprise a 16 gauge circumference so as to allow a larger pool of the diffusion barrier comprising a hydrogel to be injected into the matrix channel as compared to hydrogel pools allowed to be injected into matrix channels having inlets and outlets with an 18 gauge circumference.

9. The microfluidic intercellular communication analysis device of claim 1, wherein the matrix channel comprises first and second arrays of transversely spaced-apart matrix ribs, the first array of the transversely spaced-apart matrix ribs is offset from the second array of the transversely spaced-apart matrix ribs by a transverse distance so as to improve diffusion barrier injection into the matrix channel as compared to diffusion barrier injection made into matrix channels having transversely aligned first and second arrays of spaced-apart matrix ribs.

10. The microfluidic intercellular communication analysis device of claim 1, wherein the donor cell channel and the recipient cell channel each comprise inlets having a larger gauge circumference than cell channel inlets structured to accommodate only isolated cells such that the donor cell channel inlet and the recipient cell channel inlet are structured to accommodate target subjects larger than isolated cells, the target subjects comprising tissues or organoids.

11. The microfluidic intercellular communication analysis device of claim 1, wherein the donor or recipient cell population is injected into respective cell channel via a tip of a pipette disposed within respective inlet for a predefined time and volume such that the cell population is transferred from the tip of the pipette to respective cell channel based on gravity, the pipette comprising the cell population.

12. The microfluidic intercellular communication analysis device of claim 1, wherein the donor or recipient cell population is extracted from its respective cell channel via an empty pipette tip disposed within the respective outlet for a predefined volume, the cell population being pushed into the empty pipette tip by injecting cell media into respective inlet via a syringe pump.

13. The microfluidic intercellular communication analysis device of claim 1, wherein the target subject comprises EVs, particles, proteins or nucleic acids, and wherein intercellular communication of the target subject is analyzed for disease progression, utilizing the target subject for delivering medicine, applying therapeutic effects, diagnostic purposes, regenerative medicine, providing immunization against at least infectious diseases or cancer, and any other appropriate investigative research.

14. A microfluidic intercellular communication analysis system, comprising:
a microfluidic intercellular communication analysis device including a coverslip and a Polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the diffusion barrier being structured to mimic extracellular matrix and conduit a target subject from the donor cell channel to the recipient cell channel through the pores, the donor cell channel and the recipient cell channel each comprising inlets and outlets having an arc angle ranging from 180° to 300°, the arc angle being structured to prevent cell aggregation in the inlets, the outlets and/or channel surfaces of the donor cell channel and the recipient cell channel; and
an imaging device couplable to the microfluidic intercellular communication analysis device and structured to automatically and continuously acquire images of the target subject within the plurality of microfluidic channels for a predefined period upon injection of the donor cell population and the recipient cell population into respective cell channels, wherein the acquired images are analyzed for intercellular communication of the target subject, and/or functional characterizations for ensuing intercellular communication effects.

15. The microfluidic intercellular communication analysis system of claim 14, wherein the imaging device comprises a microscope, a camera or other appropriate image capture devices.

16. A method of performing intercellular communication of a target subject, comprising:
providing a microfluidic intercellular communication analysis device that includes a coverslip and a Polydimethylsiloxane (PDMS) layer attached to upper surface of the coverslip, the PDMS layer comprising a plurality of microfluidic channels each having an inlet and an outlet, the plurality of microfluidic channels comprising a donor cell channel structured to receive a donor cell population, a recipient cell channel structured to receive at least a recipient cell population and a matrix channel comprising a diffusion barrier having pores, the diffusion barrier being structured to mimic extracellular matrix and conduit the target subject from the donor cell channel to the recipient cell channel through the pores, the donor cell channel and the recipient cell channel each comprising inlets and outlets having an arc angle ranging from 180° to 300°, the arc angle structured to prevent cell aggregation in the inlets, the outlets and/or channel surfaces of the donor cell channel and the recipient cell channel;
injecting the donor cell population including the target subject into the donor cell channel via an inlet of the donor cell channel with an injection device;
injecting the recipient cell population into the recipient cell channel via an inlet of the recipient cell channel with the injection device;
acquiring images of the target subject within the plurality of microfluidic channels via an imaging device over a period; and
analyzing the target subject based at least in part on the acquired images, and/or functional characterizations for ensuing intercellular communication effects.

17. The method of claim 16, wherein the providing a microfluidic intercellular communication analysis device comprises:
selectively activating the matrix channel by a plasma pulse directed only at the matrix channel using an electrode placed in an outlet of the matrix channel and a tip of a plasma generator placed in an inlet of the matrix channel with inlets and outlets of the donor cell channel and the recipient cell channel being blocked.

18. The method of claim 16, wherein the injecting the donor cell population and the injecting the recipient cell population each comprises:
injecting into respective cell channel via a tip of a pipette disposed within respective inlet for a predefined time and volume such that the cell population is transferred from the tip of the pipette to respective cell channel based on gravity, the pipette comprising the cell population.

19. The method of claim 16, further comprising:
extracting at least one of the donor cell population and the recipient cell population.

20. The method of claim 19, wherein the extracting at least one of the donor cell population and the recipient cell population comprises:
placing an empty pipette tip within respective outlet;
upon placing the empty pipette tip within respective outlet, injecting cell media into respective inlet via a syringe pump; and
receiving the at least one of the donor cell population and the recipient cell population into the empty pipette via the tip for a predefined volume.
